(19) United States
(12) Patent Application Publication
(10) Pub. No.: US 2026/0237039 A1
(43) Pub. Date: Aug. 13, 2026

(54) DRILL BIT CUTTER IDENTIFICATION AND GRADING

(71) Applicant: Schlumberger Technology Corporation, Sugar Land, TX (US)

(72) Inventors: Gautam Kumar Vadisala, Pune (IN); Swayan Jeet Mishra, Pune (IN); Sachin Vilas Gaikwad, Pune (IN); Rajgopal Kedarnath Tapade, Pune (IN); Arpan Gautam, Pune (IN); Abhishek Dubey, Pune (IN); Ryan Worth Eldredge, Houston, TX (US); Niharika Kumari, Pune (IN); Bhavantik Gondaliya, Pune (IN); Jeffrey D. Leisey, Huntsville, TX (US)

(21) Appl. No.: 19/050,143

(22) Filed: Feb. 11, 2025

(51) Int. Cl. G06T 7/00; E21B 12/02; G06T 7/20; G06T 7/73; G06V 20/40; G06V 20/50

(52) U.S. Cl. CPC G06T 7/0002; E21B 12/02; G06T 7/20; G06T 7/74; G06V 20/46; G06V 20/50; G06T 2207/10016; G06T 2207/30164

(57) ABSTRACT

A method for identifying, ordering, and dull-grading a plurality of cutters on a drill bit includes capturing a plurality of frames of a plurality of blades on a drill bit. The method also includes capturing a plurality of frames of a plurality of blades on a drill bit and identifying a plurality of cutters on each of the blades in the frames. The method also includes identifying a first subset of the cutters that are primary cutters and arranging the primary cutters in a first order, and identifying a second subset of the cutters that are secondary cutters and arranging the secondary cutters in a second order. The method also includes extracting a thumbnail image of each of the cutters from the frames in the first order and/or the second order. The method also includes identifying cracks and/or erosion damage on the cutters based upon the extracted thumbnail image.

### BACKGROUND

Conventional methods for grading cutters on drill bits are manual, time-consuming, and prone to human error. This inefficiency can lead to inaccurate grading, which affects the performance and lifespan of the drill bits. Additionally, manual grading involves skilled labour, which adds to operational costs and can be a bottleneck in the production process. Therefore, what is needed is an improved system and method for identifying and grading cutters on a drill bit.

### SUMMARY

A method for identifying, ordering, and dull-grading a plurality of cutters on a drill bit is disclosed. The method includes capturing a plurality of frames of a plurality of blades on a drill bit. The method also includes capturing a plurality of frames of a plurality of blades on a drill bit. The method also includes identifying a plurality of cutters on each of the blades in the frames. The method also includes identifying a first subset of the cutters that are primary cutters and arranging the primary cutters in a first order. The method also includes identifying a second subset of the cutters that are secondary cutters and arranging the secondary cutters in a second order. The method also includes extracting one or more thumbnail images of each of the cutters from the frames in the first order and/or the second order. The method also includes identifying cracks and/or erosion damage on the cutters based upon the one or more extracted thumbnail images.

A computing system is also disclosed. The computing system includes one or more processors and a memory system. The memory system includes one or more non-transitory computer-readable media storing instructions that, when executed by at least one of the one or more processors, cause the computing system to perform operations. The operations include capturing a plurality of frames of a plurality of blades on a drill bit. The operations also include identifying a plurality of cutters on each of the blades in the frames. The operations also include identifying a first subset of the cutters that are primary cutters and arranging the primary cutters in a first order. The operations also include identifying a second subset of the cutters that are secondary cutters and arranging the secondary cutters in a second order based upon the first order of the primary cutters. The operations also include extracting one or more thumbnail images of each of the cutters from the frames in the first order and/or the second order. The operations also include identifying cracks and/or erosion damage on the cutters based upon the one or more extracted thumbnail images. The operations also include displaying the one or more extracted thumbnail images including the cracks and/or erosion damage.

A non-transitory computer-readable medium is also disclosed. The medium stores instructions that, when executed by one or more processors of a computing system, cause the computing system to perform operations. The operations include capturing a plurality of frames of a plurality of blades on a drill bit. The operations also include identifying a plurality of cutters on each of the blades in the frames. The operations also include identifying a first subset of the cutters that are primary cutters and arranging the primary cutters in a first order. The operations also include identifying a second subset of the cutters that are secondary cutters and arranging the secondary cutters in a second order based upon the first order of the primary cutters. The operations also include extracting one or more thumbnail images of each of the cutters from the frames. The one or more thumbnail images of the primary cutters are extracted in the first order. The one or more thumbnail images of the secondary cutters are extracted in the second order. The one or more thumbnail images are extracted based on a weighted score that includes a blur score, a BRISQUE score, and/or a brightness score. The operations also include identifying cracks and/or erosion damage on the cutters based upon the one or more extracted thumbnail images. The operations also include displaying the one or more extracted thumbnail images including the cracks and/or erosion damage.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIGS. 2A and 2B illustrate a flowchart of a method for ordering the cutters, according to an embodiment.

FIG. 3 illustrates a flowchart of a method for tracking multiple objects in a video frame, according to an embodiment.

FIG. 4 illustrates a schematic view showing the edges of cutters and their properties, according to an embodiment.

FIG. 5 illustrates a plurality of cutters including a first primary cutter showing frames of references with respect to a cutter centroid, according to an embodiment.

FIG. 6 illustrates a plurality of cutters in a video frame displaying a square box window, according to an embodiment.

FIG. 7 illustrates a flowchart of a method for ordering the cutters by appearance, according to an embodiment.

FIG. 8 illustrates a flowchart of a method for identifying a (e.g., best) thumbnail of a cutter, according to an embodiment.

FIG. 9 illustrates an image showing a dull code selection from images listed in a training page, according to an embodiment,

FIG. 10 illustrates an image showing labelling and annotating an area for training images from a web UI, according to an embodiment.

FIG. 11 illustrates a flowchart of a method for training a ML model, according to an embodiment.

FIG. 12 illustrates a table comparing damage on two scans cutter-by-cutter, according to an embodiment.

FIG. 13A illustrates a flowchart of a method for generating data for comparison, and FIG. 13B illustrates a flowchart of a method for rendering data for comparison, according to an embodiment.

FIG. 14 illustrates a flowchart of a method for generating a circle or ellipse on the cutters, according to an embodiment.

FIG. 15 illustrates an image of a Tkinter tool hovering over an image, according to an embodiment.

FIG. 16 illustrates a flowchart of a method for detecting the number of blades on a drill bit, according to an embodiment.

FIG. 17 illustrates a flowchart of a method for capturing a video of a blade, according to an embodiment.

FIG. 18 illustrates a frame from a video showing a focal window that aids users in capturing clear images of cutters, according to an embodiment.

FIGS. 19A-19C illustrate images showing how to address a missing cutter, according to an embodiment.

FIG. 20 illustrates a flowchart of a method for identifying, ordering, and dull-grading cutters on a drill bit, according to an embodiment.

FIG. 21 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

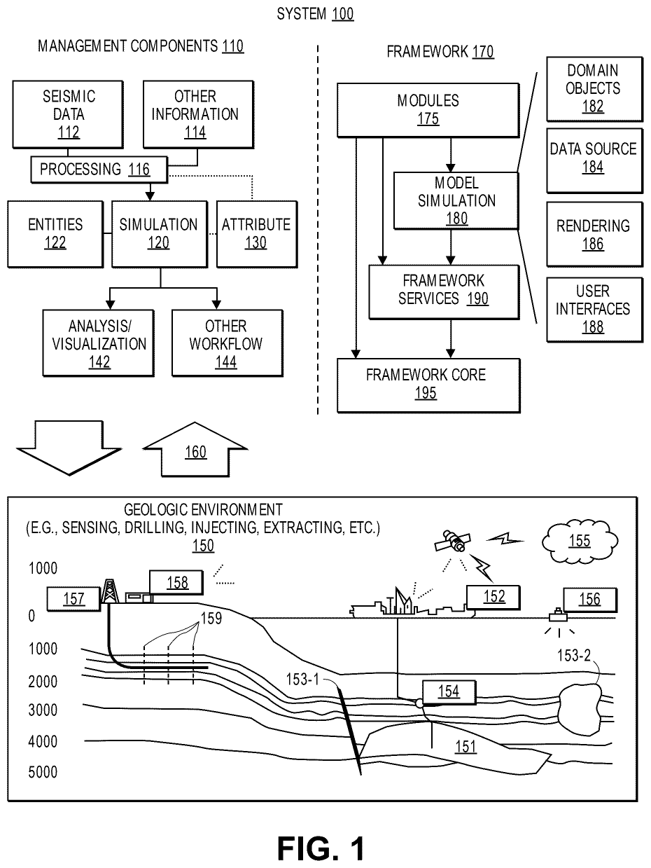

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116 (e.g., including calibration of the processing results with well data), a simulation component 120, an attribute component 130, an analysis/visualization component 142 and a workflow component 144. In operation, seismic data and other information provided per the components 112 and 114 may be input to the simulation component 120. The other information may be or include well data. The components, 112, 114 may be or include well data such as well logs, drilling logs, and/or cores, which may be used to calibrate the seismic data to rock and fluid properties.

In an example embodiment, the simulation component 120 may rely on entities 122. Entities 122 may include earth entities or geological objects such as wells, well data (e.g., used for calibration of rock and fluid properties), surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Real-Time Drill Bit Cutter Identification and Grading

The present disclosure provides an automated solution to scan drill bits and accurately grade the cutters thereon. This automation may allow for the omission of manual inspection, reducing the potential for human error and speeding up the grading process. As a result, the method improves the accuracy and consistency of cutter grading, enhances the performance and durability of drill bits, and lowers operational costs by reducing the reliance on skilled labour. This leads to increased efficiency and reliability in the drilling operations.

In an embodiment, the method may leverage a mobile application to simplify and automate the identification, ordering, and dull grading of drill bit cutters. By using the mobile application, users can scan the blades of a drill bit and instantly obtain information such as dull grading results, repair recommendations, and IADC dull codes. The mobile application may provide a user-friendly interface. More particularly, the mobile application provides an intuitive and accessible way for users to scan drill bit blades, making the process straightforward for both skilled and unskilled personnel.

The method may provide a comprehensive analysis. The method delivers detailed dull grading results, repair recommendations, and IADC dull codes, ensuring a thorough evaluation of the drill bit's condition. The method may also provide an improved workflow efficiency. By automating the identification and grading process, the method reduces manual effort and speeds up operations, enhancing overall workflow efficiency. The method may also provide scalability. More particularly, the method provides the ability to scan and analyze drill bits at scale, which allows for efficient handling of large volumes, making the process more manageable and cost-effective. The method may also provide accurate recommendations. More particularly, the method may provide precise repair recommendations based on the analysis, ensuring that maintenance actions are well-informed and effective. The mobile application may also provide convenience. Users can perform the above-mentioned tasks with a mobile device, offering flexibility and convenience in various working environments.

Conventional methos are difficult to use and are designed to measure a limited set of metrics. Their usage is restricted because they cater to specific tasks and involve a longer processing time. In contrast, the method described herein is user-friendly and offers comprehensive analysis capabilities for multiple aspects of drill bit evaluation. Cutter identification and grading occur in real time, enabling efficient and error-free data collection.

The method detects, tracks, and orders cutters based on the appearance in a video. The method may also provide the dull code and wear code, prediction of crack and erosion, repair recommendations, and the thumbnail images of the cutters based on the video. As mentioned above, the method may be implemented in mobile devices for extracting cutters based on the order in which they appear and providing dull characteristics of them.

As mentioned above, the method may detect and track cutters from video footage, providing an ordered list of cutters as they appear, in a mobile application. For professionals desiring an IADC dull code and general dull grading analysis, this technology simplifies the process. Users simply scan each blade of a bit individually and upload the data to the cloud. The method then meticulously tracks and orders these cutters, ensuring accurate and efficient analysis. This solution streamlines the workflow, saving time and enhancing precision in dull grading analysis.

The method may identify one or more drill bit cutters from the provided video. Conventional methods for identifying drill bit cutters are manual and time-consuming. The method described herein automates this process, ensuring accurate and efficient identification as per design specifications. The method may also extract visually optimal cutter thumbnails from the video. Manually selecting optimal thumbnails from videos can be inconsistent and prone to error. The method described herein automates this extraction, providing visually optimal thumbnails for further analysis and documentation. The method may also identify cracks and erosion on the cutters. Detecting cracks and erosion on drill bit cutters is relevant for maintenance and safety. The method leverages computer vision to accurately identify these defects, ensuring timely and effective maintenance actions. The method may also identify the right bit for the job. Selecting the appropriate drill bit for a specific task is relevant for operational efficiency. The method assists in identifying the right bit based on various parameters, improving job performance and reducing downtime. Developing machine learning models is a lengthy process. The method integrates AI-assisted labelling and optimized training processes to reduce the development time of ML models. The method may also provide user guidance to capture the video in the right way. Capturing video footage in the right way is relevant for accurate analysis. The method offers real-time guidance to users, ensuring that the video is captured in an optimal manner, leading to better analysis results.

The method utilizes a mobile application to capture cutters on a drill bit blade using object tracking and cutter ordering algorithms. The mobile application may be equipped with enhanced video capturing and effective guidance, allowing users to scan the blades of a drill bit and instantly obtain the order of the cutters, their thumbnails, and their dull grading characteristics.

Additionally, annotation assisting tools may reduce the lifecycle of ML model development by leveraging AI for data annotation tasks. The method may also compare bits used under certain job conditions and analyze damage across cutter locations. This helps to identify damage zones on the bits and recommends the least damaged bit for similar job conditions, ensuring the selection of the right bit for the job.

As mentioned above, the method provides mobile video capture. Unlike conventional methods that rely on manual inspection or desktop software, the method utilizes a mobile application to capture video of drill bit cutters. This approach is more convenient and allows for real-time analysis, providing users with instant feedback. The method also provides a comprehensive analysis. The mobile application identifies dull characteristics, detects cracks and erosion on the cutters, and provides detailed information such as dull grading results, repair recommendations, and IADC dull codes. The method also provides real-time guidance. The mobile application offers real-time guidance to users during the video capture process, ensuring that all cutters are recorded accurately. This feature helps prevent errors and omissions, which are common in manual inspections. The method also provides enhanced ML model training. The method improves the process of training ML models by leveraging AI-assisted labelling for data annotation tasks. This reduces the time and effort used for model development, making it more efficient than traditional methods. The method also provides a comparative analysis. The method provides the capability to compare drill bits used under similar job conditions and analyze damage across cutter locations. This feature helps identify damage zones and recommend the least damaged bit for future jobs, which is a unique capability not commonly found in other solutions. The method also provides integration and scalability. The mobile application integrates seamlessly with existing data systems and can be scaled to handle large volumes of data. This flexibility and scalability offer a significant advantage over more rigid, less adaptable solutions.

### Cutter Ordering by Design Data

One objective of the method is to detect the cutters from a video and produce the list of cutters in an ordered way in which they appear in the video. To get the IADC dull code of the bit and for general dull grading analysis, users scan the blades of a bit individually and upload them to the cloud. Users may receive instructions to scan the cutters in the direction of the first cutter to the last cutter. The method may track the cutters from the video frames and order them in the way they appear. One outcome is to extract cutters from the video from the way they appear and how they are designed.

To order and track cutters throughout the video, the method may use object tracking and object detection techniques on a video and accumulate the results. Object detection may be performed using an AutoML library. The method may train an object detection model to detect cutters on an image and provide predictions of dull grading codes. For object tracking on an image, the method may use Kernelized Correlation Filter (KCF)-based methods to track the objects throughout the frames of a video. In an example, multiple cutters that appear across the video may be tracked. This is called multiple object tracking.

### Multiple Object Tracking

Multiple object tracking is defined as the problem of automatically identifying multiple objects in a video. It also attempts to analyze videos to identify objects that belong to more than one predetermined class. The method may identify multiple cutters in a video frame and track them throughout the video. Here, cutters are the objects to be tracked in the video and can belong to different dull grading codes. To achieve the same, the method incorporates an approach called tracking-by-detection. The tracking-by-detection technique involves an independent detector that is applied to the video frames to obtain likely detections, and then a tracker, which is run on the set of detections. The method uses an object detection model as an independent detector to obtain the detection of cutters in a video frame. The detections extracted from video inputs may be used to guide the tracking process by connecting them and assigning identical IDs to bounding boxes containing the same target. The data association between the detections and the tracked objects may be done using the intersection over union (IoU) technique on the bounding boxes. The IoU is defined as the area of the intersection between the two bounding boxes divided by the area of the union of the bounding boxes.

### Kernelized Correlation Filter

An object to be tracked may be selected by a rectangular bounding box. The task of a tracker is to follow the object in the video by updating the bounding box parameters (X, Y coordinates on the image). The purpose of a track is to use these parameters of an object in a frame and find its location in the next frame. The method uses a KCF filter for its speed and efficiency.

The basic idea of the correlation filter tracking is estimating an optimal image filter such that the filtration with the input image produces a desired response. The desired response (i.e., object location in the next frame) is a Gaussian shape centered at the target location, so the score decreases with the distance. The filter may be trained from translated (e.g., shifted) instances of the target patch. When testing, the response of the filter may be evaluated, and the maximum gives the new position of the target. The filter may be trained on-line and updated successively with every frame in order the tracker adapts to moderate target changes.

One advantage of the correlation filter tracker is the computation efficiency. The reason is that the computation can be performed efficiently in the Fourier domain. Thus, the tracker runs in super-real time (e.g., several hundred FPS). There are both linear and non-linear (e.g., kernel) versions of the tracker that are derived from a unifying least square principle. The optimal linear filter w is found by solving the regularized least squares problem:

$${min}_{w} ( {‖ Xw - y ‖}^{2} + λ {‖ w ‖}^{2} ) \qquad ( 1 )$$

where X is a circulant matrix of the target image patch. Assuming one-dimensional data as x=[x₁, x₂, . . . , xₙ,], the cyclic shift of x is denoted as Pₓ=[xₙ, x₁, . . . , xₙ₋₁]. The cyclic shift samples form a cyclic matrix are:

$$X = C ( x ) = ( \begin{matrix}{x}_{1} & … & {x}_{n} \\ ⋮ & ⋱ & ⋮ \\ {x}_{n} & … & {x}_{1}\end{matrix} ) \qquad ( 2 )$$

The rows of X store the possible cyclic image shifts, y is the desired response, λ is a weight of the regularizer. The solution of (1) is:

$$w = {( {X}^{T} X + λ I )}^{- 1} {X}^{T} y \qquad ( 3 )$$

Since X is a circulant matrix, w in (3) can be computed quickly using Fourier domain operations

$$\hat{w} = \frac{\hat{x} ⊙ \hat{y}}{{\hat{x}}^{*} ⊙ \hat{x} + λ} \qquad ( 4 )$$

where the symbols denote: \hat{ } the Fourier image, ⊙ component-wise multiplication, * complex conjugate. Moreover, the response of the filter r on the test image z is not computed by a sliding window, but again more efficiently by:

$$\hat{r} = {\hat{z}}^{*} ⊙ \hat{w} \qquad ( 5 )$$

By using the “kernel-trick” (i.e., mapping input data by a non-linear function x→φ(x) and expressing the solution as the linear combination w=Σᵢαᵢφ(xᵢ), Equation (1) becomes:

$${min}_{α} ( {‖ K α - y ‖}^{2} + λ {α}^{T} K α ) , \qquad ( 6 )$$

where matrix K is the kernel matrix with elements of dot products k_{i,j}=φ(xᵢ)^{T}φ(j). The original problem thus becomes non-linear (i.e., kernelized ridge regression).
The solution of problem (6) is

$$α = {( K + λ I )}^{- 1} y , \qquad ( 7 )$$

which can be computed efficiently by

$$\hat{α} = \frac{\hat{y}}{{\hat{k}}^{x z} + λ} \qquad ( 8 )$$

together with the fast detection response

$$\hat{r} = {\hat{k}}^{x z} ⊙ \hat{α} . \qquad ( 9 )$$

The above equation is not valid for all kernels, but it is for e.g. the RBF Gaussian kernel:

$$k ( x , {x}^{′} ) = exp ( - \frac{1}{{σ}^{2}} {‖ x ‖}^{2} + {‖ {x}^{´} ‖}^{2} )$$

which leads to

$${k}^{xx ′} = exp ( - \frac{1}{{σ}^{2}} ( {‖ x ‖}^{2} + {‖ {x}^{´} ‖}^{2} - 2 {ℱ}^{- 1} ( {\hat{x}}^{*} ⊙ {\hat{x}}^{′} ) ) ) \qquad ( 10 )$$

### Tracking and Ordering

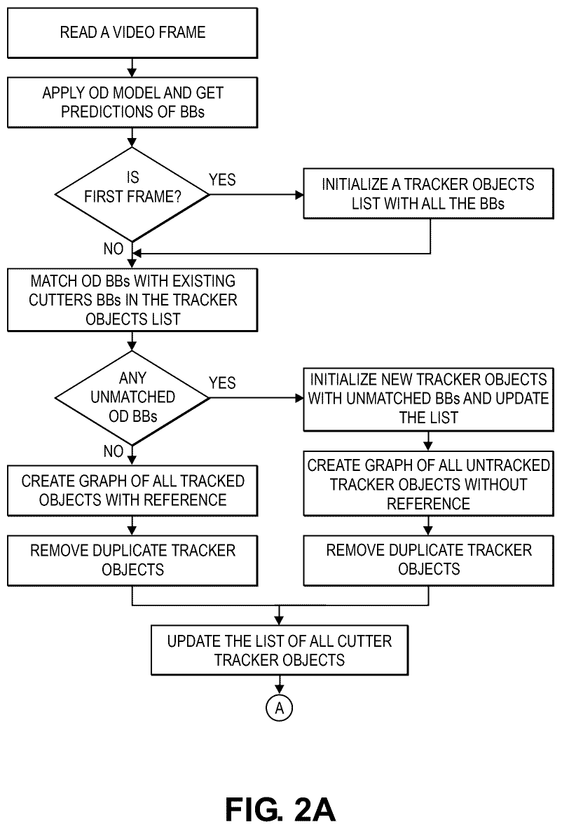

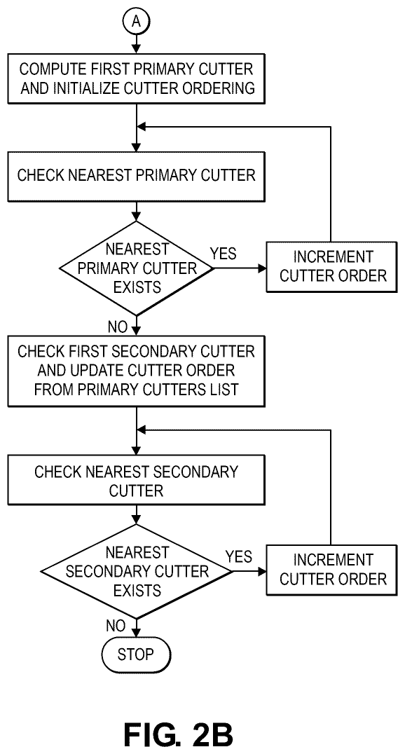

FIGS. 2A and 2B illustrate a flowchart of a method for ordering the cutters, according to an embodiment. The abbreviation OD stands for object detection and BB stands for bounding box. The method involves the following processes:
1. Splitting video and processing frames
2. Using object detection model for cutter detections and dull grading
3. Cutter Tracking Initialization and Matching
4. Graph creation.
5. Duplicate cutters removal
6. Primary Cutters ordering
7. Secondary cutters ordering

### Splitting Video and Processing Frames

The video may include cutters of a particular blade from the first cutter to the last cutter. The video capturing mechanism in the mobile application may ensure that cutters will be scanned in this order. The pace of the video, direction, and duration may be controlled in the mobile application to ensure that the cutters are properly captured in the video.

Once a video is sent for processing, it may be split into individual frames for further processing. Although each frame may be read and processed, it takes more time to process and adds little to no value to the final output. Thus, the method may analyze a predetermined number of frames that can be skipped to produce results without losing much value. The method ensures that the videos have a minimum of 4 seconds and a maximum of 30 seconds duration. For videos less than 5 seconds, the method can process every 3^{rd} consecutive frame, and for videos with more 6 seconds duration, the method can process every 5^{th} consecutive frame. Once a frame is selected, the method may ensure that it will have either 720p or 1080p resolution depending upon the height and width of the frame. For example, if the video has height and width as 1920 and 1080, it may have 1080p resolution. If it has height and width more than the specified, the method may resize the frame to have 1080p resolution. If it has height and width less than the specified, the method may resize it to 720p resolution. This is because the current algorithm can handle video frames of this resolution. The method also ensures that video is taken in the portrait mode so the height will be larger than width. If this does not occur, then the method rotates the frame.

### Object Detection Model

Once a frame is identified for processing, the method may send it to the object detection model to identify cutters on it and determine the possible dull grading characteristics identified on the cutter. This model may be trained to identify a class which has the dull code, wear code and the primary and secondary type of cutter. The classes are generated by combining the dull codes, wear code, and the information mentioning whether it is a primary or secondary cutter. The method combines the codes using the hyphen “_” for easy understanding.

For example, if a cutter has dull code as BT, wear code as T2, and it is a primary cutter, then the method may annotate that cutter as BT_T2_P_X. The last character represents the dimension information, which is generally absent in most cutters, except for the stinger, which may be tagged as X_X_P_ST or X_X_S_ST depending upon primary or secondary cutter. In the current dull grading model, the training data may be annotated for 37 such dull and wear code combinations and trained the model.

The model may be trained using the auto-ML libraries provided by the Google Cloud Platform (GCP) to deploy in an on-premises settings. The object detection model provides multiple possible detections of the cutters and their dull grading characteristics. The results obtained from the model can contain many duplicates and unwanted predictions. A non-maximum suppression method may be used to delete the unwanted (e.g., duplicate) predictions on a frame.

The object detection model can provide many different results. The first one is the confidence scores or the probability scores of the dull grading class. The second one is the bounding boxes of the detected cutters, and it may have the coordinates of the top left corner and the bottom right corner of the bounding boxes. The third one consists of the classes to which the cutters belong. To ensure multiple boxes are not selected for a cutter, every two bounding boxes may be selected, and the area of intersection is determined between them. This area may then be divided by the area of union of the boxes, which is called the Intersection under the union (IoU) score. If the score is more than about 0.3, then the method may delete the bounding box with less confidence score and preserve the one with higher confidence score. This process may be repeated until the method is left with the bounding boxes with no intersections.

### Tracking, Initialization, and Matching

Once the object detection results are obtained, the method uses them to either initialize tracking objects or match them with the existing cutters. When processing the first frame of the video, the method may initialize the tracking objects with the bounding boxes of the cutters obtained from the model. For example, if the method detects 3 cutters in a frame, the method may instantiate 3 cutter tracking objects to track the occurrence of them throughout the video and create a list.

The tracked object has attributes such as unique ID, label containing dull grading tag, Boolean variable differentiating primary from secondary cutter, Boolean variable mentioning whether the cutter object is detected by the ML model in the frame, Boolean variable mentioning the status of the tracker, bounding box coordinates, confidence score of the bounding box, order of the cutter in which it appears, and other few attributes to save the history of labels and bounding boxes throughout the video. The cutter objects created with the above attributes may be stored in a list to check their occurrence in the subsequent frames and update the order.

The KCF algorithm in the OpenCV library may be used to create tracking objects. These objects may initialize with the bounding boxes in the first frame to track them throughout the video. The tracking may be be off in some cases where bounding boxes are displaced with respect to cutter locations. Thus, the method may use tracking along with object detection to make sure that tracking objects are correctly identified in each consecutive frame. Each frame may include the tracked objects and the bounding boxes obtained from the object detection model. The method may then match each tracked object with the best possible bounding box from the model results. This may be done using IoU scores. The method may determine the IoU scores between the tracker cutter bounding box and the bounding boxes from the model and select the box which has an IoU score more than 0.5. When multiple boxes satisfy this criterion, the method may select the one that has the maximum confidence score. This may ensure that the attributes of the tracked objects are updated with the object detection model results.

In subsequent frames, there may be a possibility that the cutters may disappear, and their tracking stops. This may be identified using the Boolean variable explaining whether the tracked object can be matched with the object detection results. Similarly, the method can also observe a few cutters that the model has detected but are not yet present in the list of tracked objects. In such case, the method may initialize new cutter objects for such bounding boxes and update them in the tracked object list. Adding new cutters may include some duplicity in the tracked object list, and techniques may be implemented to reduce this.

### Graph Creation of Cutter Edges

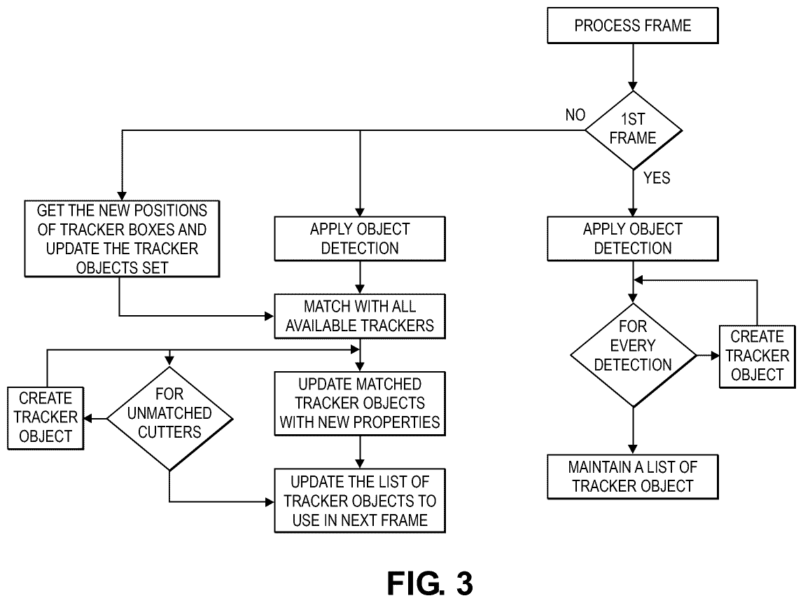

FIG. 3 illustrates a flowchart of a method for tracking multiple objects in a video frame, according to an embodiment. A unidirectional graph may be created among the cutters for checking their spatial positions with respect to each other and to determine their ordering eventually. From the above processes, the method may obtain a list of tracked cutter objects which have the information of cutter bounding boxes. The method may use these bounding boxes to compute the centroids of the bounding boxes for each cutter in the tracked cutters list. These centroids may then be used to create edges among cutters, and they are defined with two properties: distance and angle. The distance is the Euclidean distance between two centroids of cutter bounding boxes on an image plane. The angle is defined as the angle of the edge with respect to a horizontal line in a counterclockwise direction.

In an example, two cutters C1 and C2 may have bounding box coordinates as [xmin_{c1}, ymin_{c1}, xmax_{c1}, ymax_{c1}] and [xmin_{c2}, ymin_{c2}, xmax_{c2}, ymax_{c2}], respectively. The method determines the centroids (x_{cen1}, y_{cen1}) and (x_{cen2}, y_{cen2}) for C1 and C2 using these bounding box coordinates. Using these centroids, the method creates an edge between C1 and C2 with two properties distance d₁₂ and angle a₁₂ as follows:

$$( {x}_{cen 1} , {y}_{cen 1} ) = ( \frac{x {min}_{c 1} + x {max}_{c 1}}{2} , \frac{y {min}_{c 1} + y {max}_{c 1}}{2} ) \qquad ( 11 )$$

$$( {x}_{cen 2} , {y}_{cen 2} ) = ( \frac{x {min}_{c 2} + x {max}_{c 2}}{2} , \frac{y {min}_{c 2} + y {max}_{c 2}}{2} ) \qquad ( 12 )$$

The distance of edge d12, connecting C1 with C2 is defined as:

$${d}_{12} = \sqrt{{( {x}_{cen 1} - {x}_{cen 2} )}^{2} + {( {y}_{cen 1} - {y}_{cen 2} )}^{2}} \qquad ( 13 )$$

Similarly, angle a₁₂ in degrees is computed between centroid of C2 with respect to centroid of C1 from the C1 horizontal frame of reference as:

$${a}_{12} = {tan}^{- 1} \frac{( {y}_{cen 2} - {y}_{cen 1} )}{( {x}_{cen 1} - {x}_{cen 2} )} * \frac{180}{π} \qquad ( 14 )$$

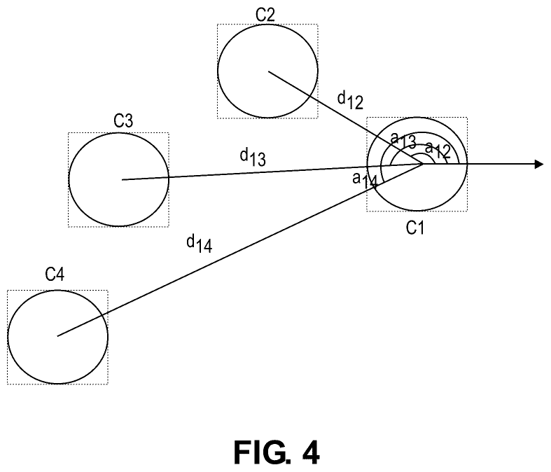

FIG. 4 illustrates a schematic view showing the edges of cutters and their properties, according to an embodiment. In FIG. 4, three edges are created between C1 and C2, C1 and C3, and C1 and C4, and the distance and angles may be d₁₂, d₁₃ and d₁₄ and a₁₂, a₁₃, a₁₄, respectively. Using the above terminology, the method creates edges between the cutters present in the tracked object list. For example, if there are 4 cutters in the list, there would be a total of 12 edges each with distance and angle properties.

### Duplicate Cutters Removal

There is a possibility that there may be duplicates in the tracked cutter list. These duplicates create an issue with cutter ordering and the creation of extra cutters which are not useful for the outcome. Thus, it is helpful to identify the duplicates from the list and remove them. The duplicate removal is done for two different sub-lists inside the tracked cutter list. In the list of tracked cutters, some cutters won't be present in the frame, and their respective status is provided by the tracking algorithm. Using this status, the method may split the tracked cutters list to sub lists in which one consists of the cutter objects with active tracking status, and the other with cutter objects which are absent or have no active tracking status. The duplicates removal algorithm may be used when there are some cutters with active tracking status. For simplicity, the cutters with active tracking status may be referred to as present cutters and the remaining ones as missing cutters.

To remove duplicates from the missing cutters, the method may create edges between each cutter in the present cutters list and the cutters in missing cutters. The method may ensure that edges are not created between the cutters in the present cutters list. Similarly, to remove duplicates from the present cutters, the method may create edges between each cutter in the missing cutters list and the cutters in present cutters. The method may not create edges between the cutters in the missing cutter list. The algorithm used for removal of duplicates cutters is similar for both the lists.

For cutter in the cutters list, the method may include checking cutter edges with respect to the cutter with distance <100 pixels and same label and different ID. Then, the method may remove these cutters from cutters_list. Next, the method may include identifying the duplicate of these cutters and compute the IoU of the duplicate and the cutter. If the IoU<=0.3, then the method may ignore and move to the next cutter; otherwise, the method may remove the cutter from list of tracked objects. Next, the method may update the attributes of the cutter with the duplicate. Next, the method may remove the edges involving the cutter from each of the cutters in the tracked objects list. Finally, the method may delete the cutter object.

Once the duplicates are removed from the present cutters list and missing cutters list, the method may proceed to ordering the cutters. The ordering may be done for primary and secondary cutters separately as their spatial positions are different. To differentiate the primary from secondary cutters, the method may use the label attribute in the cutters which mentions tag ‘P’ and ‘S’ to differentiate primary and secondary cutters.

### Primary Cutter Ordering

The method may create a list of primary cutters tracked objects for ordering. This may be referred to as the to-visit list. After that, the method may first determine the first cutter from the list of tracked cutters. In some cases, the method may also fix the first cutter if it is wrongly identified. Once the first cutter is identified, the method may update the order attribute of the tracked object associated with the first cutter to 1. The method may simultaneously maintain a variable to update the order of the cutter that is being checked. Once the first cutter is identified, the method may search for the nearest primary cutter close to that cutter in the 3^{rd} quadrant. The method may then update the order of the nearest primary cutter. Similarly, the method may use this logic to parse through each of the cutters until the cutters in the to-visit list created for ordering purposes is exhausted.

The pseudo code for primary cutter ordering is:

| • | Make a “to_visit” list of primary cutter ids to visit for ordering | |
|---|---|---|
| • | If len(to_visit) > 3: | |
| | ∘ | fix_first_cutter( ) |
| • | first_cutters = find_first_cutters( ) | |
| • | first_cutter = cutter which is most closest to top right in find_first_cutters( ) | |
| • | Initialize all order of all cutters to 0 | |
| • | current_order = 1 # Create a variable to increment its value | |
| • | current_cutter = first_cutter | |
| • | visited_ids = [ ] | |
| • | while len(to_visit) > 0: | |
| | ∘ | current_cutter.order = 1 |
| | ∘ | visited_ids.append(current_cutter.id) |
| | ∘ | to_visit.remove(current_cutter.id) |
| | ∘ | nearest_primary = find_nearest_primary_in_3^{rd}_quadrant(current_cutter) |
| | ∘ | if nearest_primary is None or nearest_primary.id not in to_visit: |
| | | ▪ break |
| | ∘ | else: |
| | | ▪ current_cutter = nearest_primary |
| | ∘ | current_order += 1 |

The terms fix_first_cutter( ), find_first_cutter( ) and find_nearest_primary_in_3^{rd}_quadrant( ) are the methods used in the primary cutter ordering. The methodologies involving finding the first primary cutter, fixing first primary cutter, and finding nearest primary cutter in the 3^{rd} quadrant are explained in the below sections.

### First Primary Cutter Identification

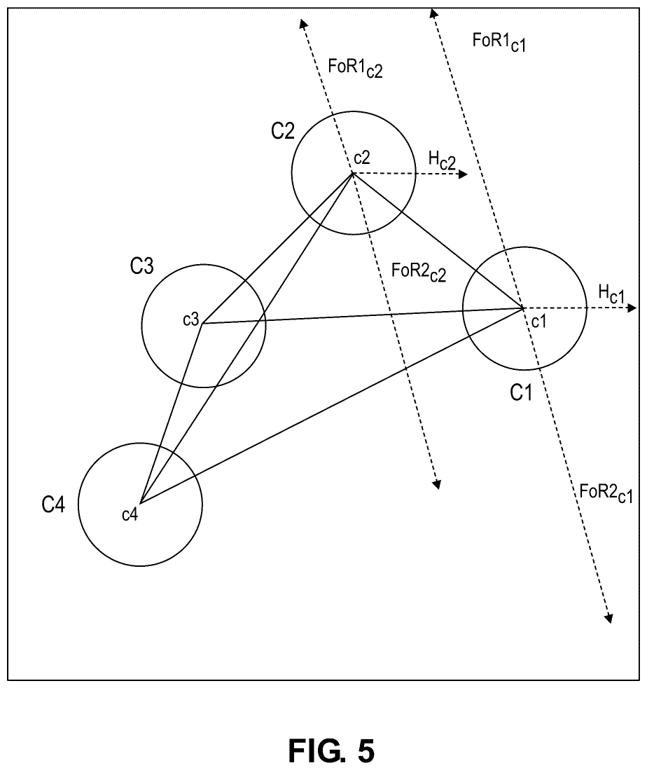

FIG. 5 illustrates a plurality of cutters including a first primary cutter, according to an embodiment. In FIG. 5, the cutters C1, C2, C3, and C4 may be present in a frame. The method may define their centroids as c1, c2, c3, and c4. The edges may be present between each of the cutter centroids. As previously explained, the method may compute angles of edges with respect to a cutter from its horizontal frame of reference. The H_{c1} and H_{c2} are the horizontal line of references from centroids c1 and c2. To determine the location of the first cutter in the frame, the method may create a frame of references around each cutter's centroid. These frames of references are imaginary lines located at angles of 105 degrees and 295 degrees with respect to cutter centroids from their horizontal line of references. The terms FOR1_{c1} and FOR2_{c1} are frames of references with respect to centroid c1, and FOR1_{c2} and FOR2_{c2} are frames of references with respect to centroid c2.

To be a first primary cutter, the cutter may have the cutter centroids of its edges on the left side of the frame of the references. That is, the edges of the cutter should be located between 105 degrees and 295 degrees with respect to its horizontal frame of reference. In this example, C1 is a first cutter because its edges to other cutter centroids are on the left side of the frames of references. Whereas for cutter C2, it has cutter C1 which is located on the right side and hence it won't be a first cutter. Similarly, C3 and C4 also won't satisfy the properties of the first cutter. In this example, the properties of the first cutter are satisfied by one or more cutters, and the method selects the cutter which is closest to the top right corner and will give its order as 1.

### Fixing First Primary Cutter

In some cases, there is a possibility of identifying the wrong cutter as the first cutter, and it may hamper the ordering of cutters and their actual representation in the blade video. Thus, each time that a frame is processed for ordering, the method may first take the first cutter that is detected from the previous method. The method may then identify the nearest primary cutter to that first cutter. For simplicity, let's call it the second cutter. Then, the method may again check if there is any nearest primary cutter to that and call it the third cutter. In cases where there is not a second or third cutter, this may be exited or omitted. The method may also check for two angle measurements. The first one is the angle of second cutter centroid from the first cutter centroid with respect to its horizontal frame of reference. The second one is the angle of third cutter centroid from the second cutter centroid with respect to its horizontal frame of reference. If the first computed angle is greater than second angle, and the absolute difference in the angles is more than 30 degrees, then the method may change the second cutter to the first cutter and exit the process.

### Nearest Primary Cutter

The purpose of checking nearest primary cutter is to navigate to the nearest primary cutter from a cutter and update its order. The logic for checking nearest primary cutter with respect to a cutter uses the edges in the graph that are created. Here, the method checks the nearest edge from the available edges of the primary cutters that are located at angle between 135 degrees and 285 degrees from the cutter centroid.

### Secondary Cutter Ordering

The ordering of secondary cutters is like the ordering of primary cutters apart from the difference in identifying the locations of the secondary cutters. Here too, the method may maintain a list of tracked secondary cutter objects that are yet to be visited for ordering purposes. The method may first obtain the first secondary cutter from the list of cutter objects. The method may then check the nearest secondary cutter from the cutter and update the order of the cutter. Similarly, the method may use this cutter to check the nearest secondary cutter and update its order. This process may be continued until each of the cutters are exhausted in the list.

The pseudo code for secondary cutter ordering is:

| • | Make a “to_visit” list of secondary cutter ids to visit for ordering | |
|---|---|---|
| • | If len(to_visit) == 0: | |
| | ∘ | exit |
| • | first_secondary_cutter = find_first_secondary_cutter( ) | |
| • | current_order = number of primaru cutters + 1 # Create a variable to increment its value | |
| • | current_cutter = first_secondary_cutter | |
| • | visited_ids = [ ] | |
| • | while len(to_visit) > 0: | |
| | ∘ | current_cutter.order = 1 |
| | ∘ | current_cutter += 1 |
| | ∘ | visited_ids.append(current_cutter.id) |
| | ∘ | to_visit.remove(current_cutter.id) |
| | ∘ | nearest_secondary = find_nearest_secondary_in_3^{rd}_quadrant(current_cutter) |
| | ∘ | if nearest_secondary is None or nearest_secondary.id not in to_visit: |
| | | ▪ break |
| | ∘ | else: |
| | | ▪ current_cutter = nearest_secondary |

The terms find_first_secondary_cutter( ) find_first_cutter( ) and find_nearest_secondary_in_3^{rd}_quadrant( ) are the methods used in the secondary cutter ordering.

### First Secondary Cutter Identification

For Identifying the First Secondary Cutter, the Method May Use the List of Visited Primary cutters. This list is already sorted based upon the above primary cutter ordering algorithm. Thus, the method may parse through the list and check, for each primary cutter, if there is any nearest secondary cutter which is located within 80 to 310 pixels (or 400 depending upon the video resolution) of distance and at angle between 80 degrees to 190 degrees with respect to the primary cutter. This distance and angle are the properties of the cutter edges which were created earlier. If such nearest secondary cutter exists, then the method may exit the loop and return that cutter as nearest secondary cutter.

### Nearest Secondary Cutter

One purpose of checking the nearest secondary cutter is to navigate to the nearest secondary cutter from a secondary cutter and update its order. The logic for checking the nearest secondary cutter with respect to a secondary cutter also uses the edges in the graph discussed above. Here, the method may check the nearest secondary cutter edge from the available edges of the cutters that are located at an angle between 135 degrees and 285 degrees from the cutter centroid. If such a secondary cutter exists, then the method may use this cutter to update the order of available secondary cutters.

### Edge Optimized Cutter Tracking Algorithm

The above-mentioned tracking algorithm may be implemented for the processing of videos on the backend of the web application. However, the algorithm may not be optimized or designed to run on the edge devices. For that, the method may include few changes in the algorithm such as the introduction of square box and ordering cutters based on the appearance, etc.

The steps involved in the tracking and ordering algorithm are similar to those discussed above, but the cutter ordering differs in the following processes. The method may (1) introduce a square box (or Area of interest), (2) order the cutters by appearance, and stop unwanted trackers.

### Detections in Square Box

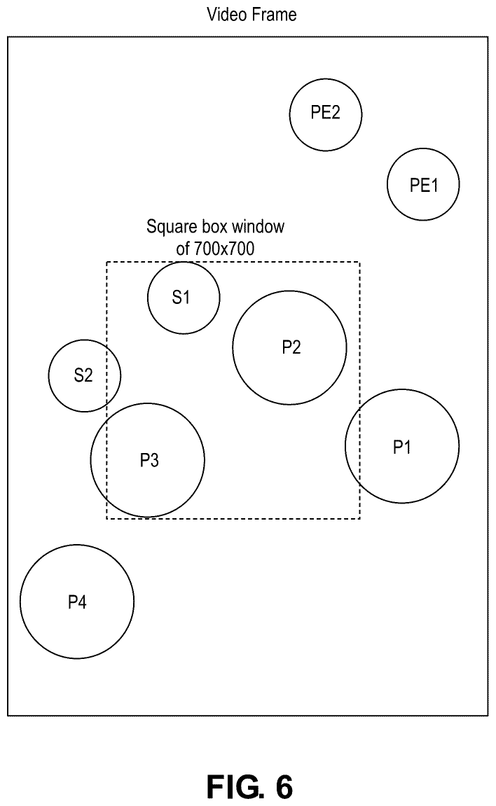

FIG. 6 illustrates a plurality of cutters in a square box inside a video frame, according to an embodiment. More particularly, the method may introduce a square box of width 400×400 (in pixels) on the UI of a mobile application to capture the primary cutters properly. This is an area of interest which helps capture the cutters with more visibility and focus, and it may help to reduce the capturing of cutters on the other blades. As the targeted cutters exist in the square box, the method may expand that area of interest by another 200 pixels to accommodate secondary cutters as well and use them for tracking and ordering.

The method may (1) use the entire frame and send it to ML model for cutter predictions, (2) filter the cutters which are entirely in the 700×700 window, and (3) start the trackers for them.

In an example, P2 and S1 entirely may be in a square box window, so it may be used for tracking and ordering. As P3 lies outside the border, even if it is slightly outside the 700×700 window (which includes a 50-pixel buffer), it will be discarded.

To improve accurate detection and tracking, the method may check to see if the bounding box is outside a 700×700 window. Here, a 600×600 window is taken with a 50-pixel buffer, making it a 700×700 window. The method may also ensure that the bounding box is not too close to the frame's edges, where the side of the cutter should be inside the 700×700 window by at least 5 pixels, or else, it is discarded. The method may also verify that the bounding box meets minimum height and width standards. The method may also ensure that the aspect ratio of the bounding box is valid (e.g., less than 2).

If any of the above conditions are met, the method may check to see if the center of the bounding box is within 350 pixels of the frame's center. If the center is not within this range, the bounding box may be discarded. Otherwise, the bounding box may be kept for further processing.

### Cutter Ordering by Appearance

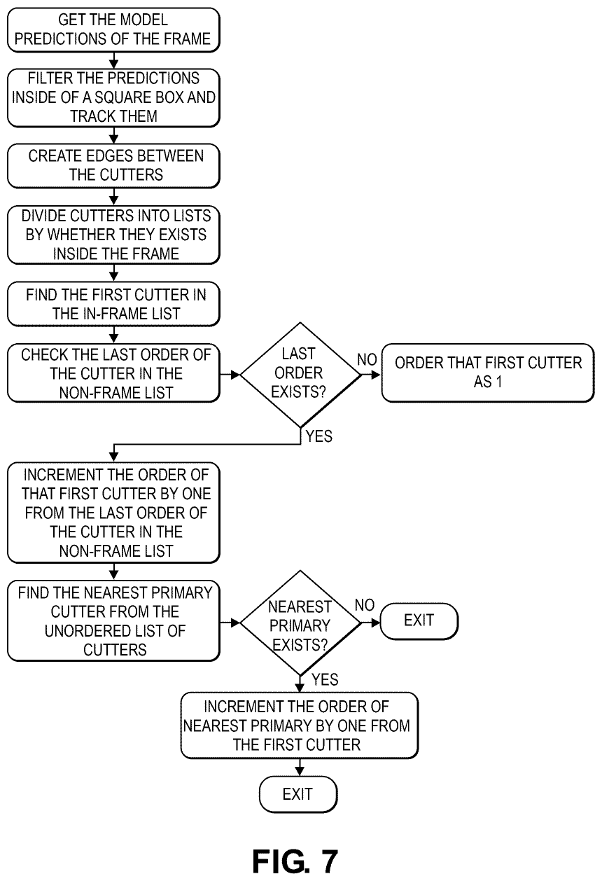

FIG. 7 illustrates a flowchart of a method for ordering the cutters by appearance, according to an embodiment. One difference from the previous logic is that the method no longer finds the first cutter in every frame. Instead, the method may rely on cutters that have already been ordered before and have passed out of the frame. The method may detect the cutters in each frame. The method may then filter the cutters based on the window size. The method may also update the tracker. If an object matches, the tracker may be updated; otherwise, a new tracker may be created. The method may then create lists of tracked and untracked cutters. More particularly, edges for both primary and secondary cutters may be created separately. The method may also create in-frame and non-frame lists for both primary and secondary cutters. The method may also order the first primary cutter based on the in-frame and non-frame cutter lists. The same process may be applied for secondary cutters. The method may also remove un-ordered and untracked cutters from the lists. Finally, this process may continue/loop for each of the frames in the video.

### Stop Tracking Unwanted Trackers

Although the method removes duplicate cutters and false cutters from the list on every frame, some cutters may be found that are still used in the ordering process but are not beneficial and consume memory. To mitigate this, tracking of the cutters that aren't useful for ordering may be stopped. More particularly, the method may after ordering the eligible cutters, if any cutters are left with an order of 0 and are still in the in-frame list, they may be removed. If an ordered edge's angle is between 270 degrees and 310 degrees degrees, the tracked object has a non-zero order, and the ordered edge's distance is greater than 600, these false trackers may be removed. This involves (1) identifying the least angle valid tracker, (2) removing the identified tracker from the tracked objects list, (3) updating the edges of remaining tracked objects by removing references to the removed tracker, and (4) adjusting the order of remaining tracked objects.

### Best Cutter Thumbnail Extraction

The method may extract and display the thumbnail of the cutter on the UI of cutter analytics (after cutter detection) using an object detection-based algorithm and ordering using a tracking algorithm. To extract the thumbnail, the method may use the blade video and extract a few frames by the defined logic. The model identifies the cutters using an object detection algorithm, and then the tracking module identifies the order of a cutter as well as tracks each cutter. Here, a cutter may be present in multiple frames and generate multiple thumbnails of the cutter. Out of multiple available thumbnail images, the best thumbnail image is identified using the method mentioned below to display over the UI.

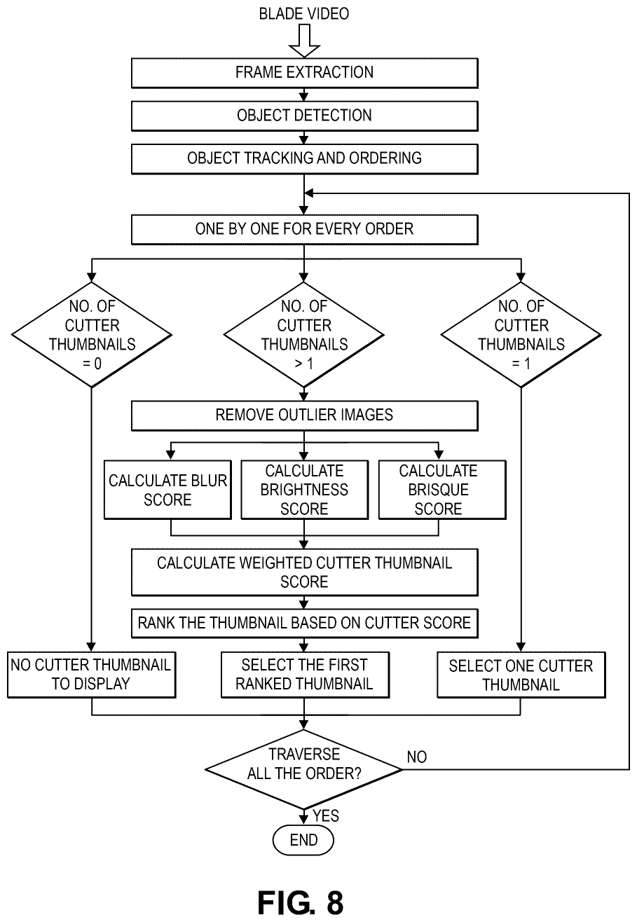

FIG. 8 illustrates a flowchart of a method for identifying a thumbnail of a cutter, according to an embodiment. Here a blade video may be received as an input, and the frame may be extracted and processed to obtain the cutters and their dull grading labels. Once the cutters are identified, the tracking module orders the cutter and extracts the multiple thumbnails of a cutter present in the video. Thumbnails are the cropped portion of the frames/images where cutters are present and used for displaying on the web application. There are three scenarios: first, if there is no cutter identified, then no thumbnail to display it. Second, if exactly one thumbnail is identified, then display it. Third, if multiple thumbnails are identified, then select the best one using the given technique. Finally, the thumbnail may be stored in the cloud and used to display on the web application.

### Extraction Process

Cutter thumbnail extraction may be used to display it on the web application and to manually analyze the position of the cutter over the blade with the bit design data. To detect and classify a cutter, an Auto ML-based image object detection model may be used. The model processes images, identifies the cutter, and labels them with their dull code, wear code, and primary and secondary positions of the cutter. Using the blade video, frames may be extracted and, depending on the length of the video, a few frames at an interval may be selected for processing. The model then identifies and predicts the class of the cutters.

The cutter thumbnail extraction process includes finding the best cutter across multiple frames. A cutter might be present in more than one frame, and it may be identified, tracked, and ordered using the cutter ordering algorithm. Here, there is a high probability that the cutter may be partially visible in the first and last frame of the video where the cutter appears in the video. So, the method may remove such thumbnails as they are considered outliers.

Conventional methods take the middle image of multiple available cutter thumbnails as the final cutter image. Here, the assumption is that the first and last thumbnails are not selected, the method takes the median of the thumbnails. Also, the cutter may be available in the middle of the frames where the cutter appears, so it provides the best capture of the cutter out of the available thumbnails. This method extracts the image based on the order of the cutter, not based on the quality of the image. Thus, it would be beneficial to have a technique to evaluate the image and extract the best quality image.

Also, there may be cutters where either the image of the cutter is not present due to cutter detection issues or tracking loss or the cutter has exactly one image. In cases where there is no image, the method may be unable to proceed, and in instances where there is exactly one image, that image may be utilized. The method may be employed to identify images when more than one is present.

For the selection of the best quality image among multiple cutter images, it may be helpful to employ a method based on quality rather than order. Thus, the method may use various techniques such as blur score, brightness, and/or BRISQUE scores, and combine them using a defined weightage. Thereafter, the method may derive a cutter thumbnail score and rank the cutters images accordingly.

In an example, the cutter may be seen in the first or last frame where the cutter may be partially visible. Here, the cutter is half present due to it either entering or leaving the frame. Also, the cutter bounding box may be rectangular rather than the usual square shape if the cutter is partially present in the frame. By utilizing the concept of a rectangular shape, the method eliminates those cutter thumbnails where height to width ratio is more than 50% and vice versa.

### Thumbnail Scoring Method

The process of cutter thumbnail scoring involves ranking multiple available images based on their individual quality. To assess quality, the method first removes images where the partial cutter is visible, and then evaluates other parameters such as blur score, brightness, and/or BRISQUE score. Based on the above three parameters by weighted average, each thumbnail may be assigned a value ranked from higher to lower to indicate the image's quality. This section focuses on the case where there are multiple thumbnails of the cutter method.

### Blur Score

In the cutter analytics, when the user captures a video of the blade, there are instances where the extracted frames from those videos might be blurry. Such images are not useful in either scenario, whether for training the model or for display over the user interface. Given the size of such a vast dataset, manually inspecting each image is not feasible. Therefore, an algorithm to automatically filter out blurry images would be useful. For that purpose, the method employs a quick Python script to perform blur detection using OpenCV.

Here, the method computes the blur score of an image using OpenCV, and the Laplacian operator. Instead of making a binary decision on whether the image is blurry or not, the method utilizes the Laplacian operator to provide a score or index that defines the blurriness of the image. To achieve this, the method first converts the color image to grayscale, which means converting from multi-channel to single channel using OpenCV. Then, the method convolves this single-channel image with the Laplacian 3×3 kernel:

```
[ 0 1 0
  1 −4 1
  0 1 0]
```

In this process, the variance of the response is also considered. The Laplacian operator may also be used for edge detection. The assumption underlying this approach is that, if an image exhibits high variance, it indicates a wide spread of responses, encompassing both edge-like and non-edge-like features, which is characteristic of a normal, in-focus image. Conversely, if the variance is very low, it suggests a minimal spread of responses, indicating a scarcity of edges in the image. As an image becomes more blurred, the number of edges decreases.

### Brisque Score

The BRISQUE algorithm compares a given image to a default model computed from images of natural scenes with similar distortions. A smaller BRISQUE score indicates better perceptual quality. The method may utilize the Python library “brisque” to obtain the BRISQUE score.

To calculate brisque score, the method may include extracting natural scene statistics (NSS). The pixel intensity distributions of natural images differ from those of distorted images. By normalizing pixel intensities and analyzing their distribution, particularly following a Gaussian distribution for natural images, deviations from this ideal distribution serve as a measure of image distortion. Calculating the brisque score may also involve mean subtracted contrast normalization (MSCN). This normalization method involves transforming image intensities to luminance values and calculating local mean and variance fields using Gaussian blur operations. MSCN coefficients are then computed based on these fields to capture image contrast. Calculating the brisque score may also involve pairwise products for neighborhood relationships. To account for neighborhood relationships, pairwise products of MSCN coefficients with shifted versions of themselves are calculated in four orientations: horizontal, vertical, left diagonal, and right diagonal. Calculating the brisque score may also involve calculating feature vectors. From the derived images, a feature vector may be generated containing 36 elements. This includes parameters from fitting generalized Gaussian and asymmetric generalized Gaussian distributions to MSCN coefficients and pairwise products. Calculating the brisque score may also involve prediction of image quality score. Machine learning techniques, such as Support Vector Machines (SVM), can be used to predict image quality scores based on the feature vectors. The trained model provided by the authors or a custom trained SVM can be utilized for this purpose.

### Brightness Score

Brightness is more properly described as the measured intensity of the pixels including an ensemble that constitutes the digital image after it has been captured, digitized, and displayed. In other words, brightness refers to the overall lightness or darkness of the image. The brightness score defines an average pixel intensity in an image. Two types of images are present: a color image with three channels (RGB or BGR), and a grayscale image that contains a single channel.

For an RGB image, the method calculates the image brightness by first computing the L2 norm along the third axis. This operation yields a matrix where each element represents the Euclidean norm of the corresponding pixel across its color channels. Next, the method computes the mean brightness by averaging these norms. To ensure normalization, the method divides this average brightness by \sqrt{3}, scaling it down to make it independent of the number of color channels. This ensures that the resulting brightness value is unbiased by the image's color representation. In summary, the expression computes the normalized average brightness of an RGB image by calculating the average Euclidean norm of the pixels across their color channels and then scaling it down to remove the influence of the number of color channels.

For the grey scale image, the method calculates the average value of the elements in the array image. In the context of an image represented as a NumPy array, this operation computes the mean intensity value of the pixels in the image. It essentially gives the average brightness of the entire image.

The pseudocode for the brightness function may include:

```
function get_brightness_score(image):
  # Check if the image is colored (RGB or BGR)
  if len(image.shape) == 3:
    # Compute brightness using Euclidean norm
    brightness = np.average(norm(image, axis=2)) / np.sqrt(3)
  else:
    # Compute brightness for grayscale image
    brightness = np.average(image)
  return brightness
```

To obtain the thumbnail score, the method may use a weighted average method, where weights are assigned based on experimental methods to the three scores. The weights provided in the example below were determined through experimental methods. However, there is a flexibility to adjust these weights to explore different combinations that may better identify the best quality of the image. In an example:

$${W}_{blur} , {W}_{bright} , {W}_{brisque} = [ 1 , 0.3 , 0.66 ]$$

$$where {W}_{blur} = Weight of the blur score$$

$${W}_{bright} = Weight of the brightness score$$

$${W}_{brisque} = Weight of the brisque score$$

The composite score may be generated as:

$$Cutter Thumbnail Score = {W}_{B L U R} * BlurScore + {W}_{Brightness} * BrightnessScore + {W}_{B r i s q u e} * BrisqueScore$$

The method may rank the thumbnails based on their cutter thumbnail score. The lower the cutter thumbnail score, the better the image quality.

### Crack and Erosion Detection on Cutters

The method may use an ML based approach to detect cracks and erosion on the cutters. Generally, cutters are cylindrical in shape and are made up of diamond and carbide. For example, the cutter base is made up of carbide, and the top cutting surface is made up of diamond. The diamond portion is used for machining operation due to its hardness.

Erosion of the cutter is the corrosion in the carbide substrate. Erosion in a cutter of a drill bit refers to the gradual wearing away or deterioration of the cutting edge or teeth of the drill bit due to friction and abrasion during drilling operations. This erosion can occur over time as the drill bit encounters various materials such as wood, metal, or concrete. Factors such as the hardness of the material being drilled, the speed of drilling, and/or the quality of the drill bit material can contribute to erosion. Erosion in the cutter can diminish the drill bit's cutting efficiency and may eventually lead to replacement to maintain optimal performance. Regular inspection and maintenance can help identify and address erosion issues.

In the context of a drill bit, a crack in the cutter refers to a fracture or breakage in the cutting edge or teeth of the drill bit. This can happen due to factors such as excessive force, improper use, or fatigue over time. Cracks in the cutter can affect the drill bit's ability to cut efficiently and may lead to a decrease in performance or even failure during drilling operations.

In an example, a blade video is taken for processing, and several frames are extracted from the video at equal interval based on the defined logic. Each individual frame may be sent to the object detection model to detect the cutter and its dull grading label. After processing the selected frames, the data proceeds to the object tracking and ordering module. Here, each cutter is tracked sequentially according to their positions on the blade, and their positions are ordered accordingly. After that, thumbnail extraction occurs where the best quality thumbnail of the given cutter is selected. Then, this thumbnail is sent to the crack and erosion model to identify the crack or erosion present in a cutter. Finally, this information is stored in the database and used to display over the UI of the cutter analytics.

In cutter analytics dull and wear characteristic identification is used to analyze the cutter condition for further operation. Similarly crack and erosion detection is used in cutter analytics. Firstly, the object detection and tracking module extracts the cutter thumbnail. Once a cutter thumbnail is extracted, it is used as an input to the crack and erosion detection model. The crack and erosion detection model may be trained on an auto-ML-based algorithm for image classification using GCP. The model classifies the given cutter thumbnails as crack or erosion. This is how the model detects cracks and erosion for each cutter in the blade of the bit. The results may be displayed over the UI.

### Leveraging Object Detection

In the oilfield, after a drilling operation using the drill bit is necessary, the drill bit may be inspected before reusing it. A technician may first take videos of each blade using the cutter analytics application. This blade video may be provided as input to the ML model where firstly, several frames at equal intervals are extracted from the video based on the defined logic. The frames are sent to the object detection model, which is trained using the auto-ML model. The model identifies the cutter, creates the bounding box, and assigns the label to the detected cutter object.

Handling the image object detection problem achieves two objectives: detecting the cutters as objects and classifying them by assigning appropriate labels. Here, the object detection model may be trained on the dataset which has the bounding box over the cutter, and it is labeled with their dull codes, wear codes, and positions on the blade (e.g., either primary or secondary). The labels are the combination of the dull code wear code and cutter position on the blade and ~37 such labels are used in the training dataset.

The output of the object detection may be used for various purposes such as tracking and ordering the cutters, thumbnail extraction, and even as input to the further models like crack and erosion models.

### Image Classification Model Explanation

An image classification model refers to a machine learning model trained to recognize and categorize objects or patterns within images. To detect cracks and erosion in the cutter, a multi-label image classification model may be used to detect cracks or erosion on the cutter. Following the image object detection, tracking, and ordering module, as well as the extraction of thumbnails, the method obtains a list of cutter thumbnails. This list is directly employed to identify the cracks and erosion in the model.

To achieve this task in cutter analytics, the model may be trained using the auto-ML-based libraries in GCP. For image classification, samples of the images are labelled as either crack or erosion and trained over the auto-ML. For the thumbnail crack and erosion prediction, the model takes as input image thumbnails and predicts cracks and/or erosion with confidence. In an example, the method may establish a threshold confidence of 0.5 experimentally. To illustrate, consider an example: if a set of thumbnails is provided to the crack and erosion model, and it predicts a crack with a confidence level exceeding the 0.5 threshold, then the method classifies it as crack. The same procedure applies for the detection of erosion. These results are displayed over the UI as “Y” Means crack/erosion is present and “N” means no crack/erosion.

### ML-Assisted Labelling

The objective is to develop a training dataset that is consistently updated with the latest data. In the real world, users generate large volumes of data, from which random samples are selected. These samples undergo modification or correction of predicted labels before being added to the training set. Here, the machine learning process extracts frames and identifies cutters and their labels. In an example, every 75th frame is randomly chosen for inclusion, constituting 1.33% of the sample dataset added to the training set.

This dataset may be showcased on the training page of the user interface (UI), where experts have the option to either delete or incorporate it into the training set after correcting any inaccuracies in the predicted labels. This data is then stored within the dataset and can be utilized later for model training purposes.

Model-assigned labelling is a process where the model assigns labels and bounding boxes to the cutters in a frame. A large amount of data is generated daily, which is neither suitable for inclusion in training nor feasible for manual inspection and correction. Hence, there is a desire to randomly select a sample of the dataset. This data is then displayed on the user interface (UI), where subject matter experts (SME) can review and either delete images or modify labels before submitting them for storage in the database and later for model training.

For random selection, the method selects every 75th frame and sends it to the training page on the web application, where an expert continuously reviews the incoming new data. Based on their expertise, frames are either selected for training or deleted. With each new model training iteration, the method incorporates the latest training dataset to ensure the model is up to date.

In a web application user interface (UI) context, a role-based access control method may be used for managing and controlling user access to specific functionalities or features based on their assigned roles. The user can add training images from the web application scan detail page when user has a ML training role.

### Training Images Source 1

As Mentioned Above, the ML Selects Every 75th Frame and Sends it to a Training Page in a web application. For each image/frame, the ML sends multiple annotation areas in the form of bounding box coordinates, indicating where the objects are located within the image, and this information is stored in the database and used to display over the UI of the cutter analytics training page.

A bounding box annotation may have the following attributes: the X-coordinate of the top-left corner of the bounding box; the Y-coordinate of the top-left corner of the bounding box; the width of the bounding box; the height of the bounding box; a parameter indicating whether the object within the bounding box is fully visible, partially visible, or not visible; NO_T0_S_LV_R (e.g., an annotation tag); a section Type: ‘-’, (e.g., cutter type: P for primary cutter and S for secondary cutter); a dull Code: ‘NO’, (e.g., dull condition); a wear Code′: ‘T0’, (e.g., wear condition); and a recommendation.

### Training Images Source 2

The user has the ability to capture any blade frame and add in training images for labeling and annotation from the web UI scan detail page. More particularly, in a web application user interface (UI) context, a role-based access control method may be used for managing and controlling user access to specific functionalities or features based on their assigned roles. Implementing mechanisms in the UI may check whether a user with a specific role has the permissions before allowing them to perform training operations.

Training images may be used to train machine learning models, allowing them to learn patterns and labels within the data. This process helps the model generalize its understanding and make accurate predictions on new data. A larger and more varied data set helps in improving the model's ability to handle different scenarios. This can be applied during training to increase the dataset size and improve model robustness.

Training images saved from real scenarios (e.g., bit scans) may provide models with a realistic understanding of the environment in which they are designed to operate. This is helpful for applications such as object detection and cutter annotation. New images are continuously added to training datasets, allowing the models to adapt and stay relevant over time.

Annotation and Labeling of Training Images from Web UI

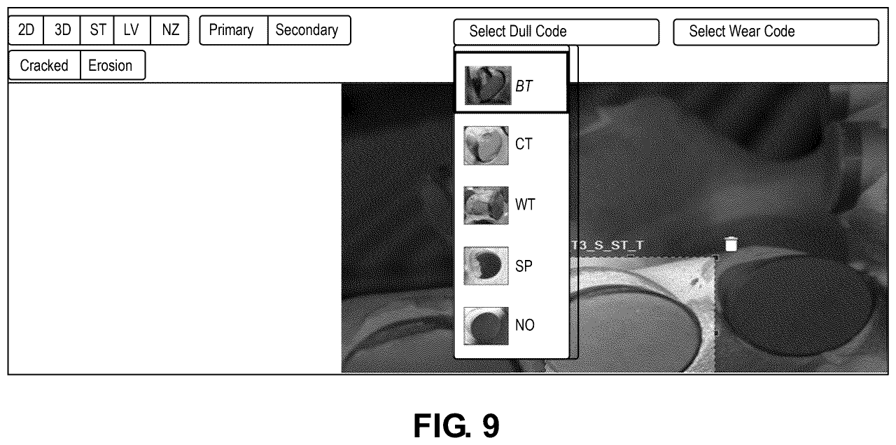

FIG. 9 illustrates an image showing a dull code selection from images listed in a training page, according to an embodiment. The user can annotate areas and add labels (e.g., dull code, wear code, location, crack/erosion, and recommendation) and mark these images as validated or training images. These training images may be used to train the machine learning model.

### Annotate Cutter Wear Recognition

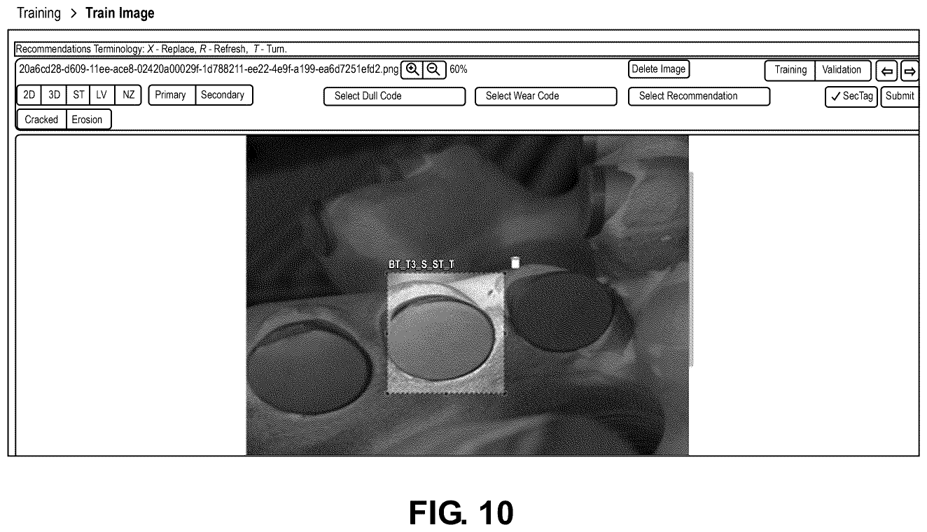

FIG. 10 illustrates an image showing labelling and annotating an area for training images from a web UI, according to an embodiment. Digitizing cutter wear characteristics may include measuring the degree of wear of a cutter by an autonomous AI system and thus measuring the remaining useful life (RUL). The RUL is measured on a scale of 0 to 8. Cutter wear may be measured across the diamond table regardless of the cutter shape, size, type, or exposure. Cutter wear may be recorded using a liner scale from 0 to 8, with 0 representing no wear and 8 meaning no diamond remaining.

### GenAI-Assisted Labelling

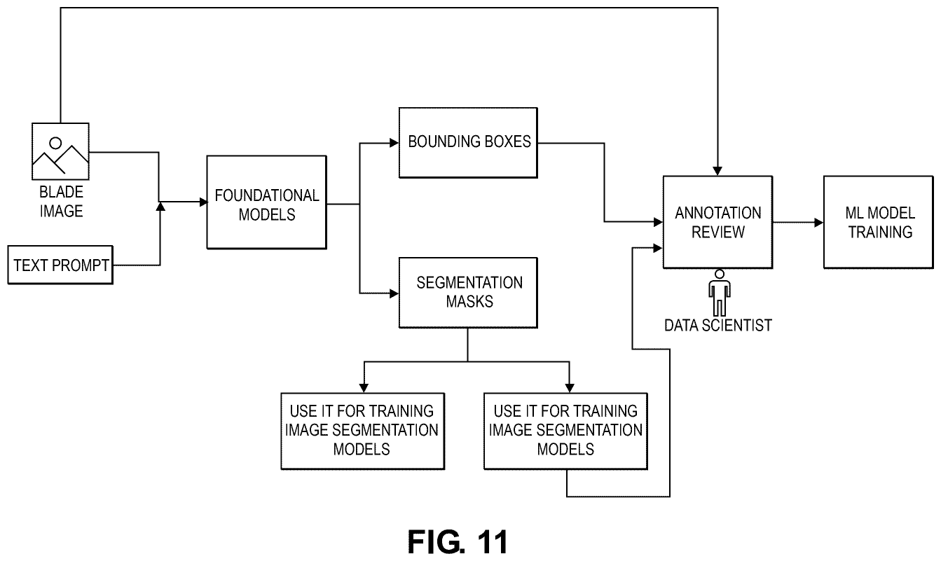

FIG. 11 illustrates a flowchart of a method for training a ML model, according to an embodiment. An objective is to use foundational models (FM) in generating bounding boxes for the cutters on the drill bits given the text prompts. The method may use the foundational models in two ways. One is to directly generate the bounding boxes of the cutters, and the other is to obtain a segmentation mask and then obtain the bounding boxes or directly use the segmentation mask for other use cases.

The method first takes the blade image and a text prompt mentioning the text of the object and sends this to a foundational model. If using models such as Grounding Dino, the method can obtain bounding boxes of the objects mentioned in the prompt. If using a segment anything model (SAM), the method can obtain segmentation masks of those objects. These segmentation masks provide the pixels corresponding to the object. This can be useful for predicting the object pixels. The bounding boxes may be used to create an initial dataset, and a data scientist can use them for annotating data which can be used for training a ML model. The segmentation masks can also be used for models which include a damage classification at a pixel level.

### Dull Grading Comparison

Data gathered during the dull grading process can be utilized to compare the results across multiple capture events (e.g., scans). During the data capture process, the method collects dull codes (e.g., the kind of damage the cutter has, and the wear code is level of damage). This comparison data gives dull grading variations and cutter condition variations between two or more scans. It can be related to the environment where the drill bit is being used and can give evidence-based data about the changes to the drill bit. This comparison can also consider the make/design of the drill bit, which can be used to perform a target damage analysis on a part or area of the drill bit.

Drill bit dull grading generates data on a cutter level (i.e., this provides, at each cutter, the dull code and the wear code). This data can be correlated to other dull grading data by the additional linking parameters such as the run or by physical design of drill bit. Changes in dull/wear conditions caused by the drilling environment and/or usage of the drill bit may be detected by performing the dull/wear condition analysis on the dull grading results captured during scans from different times.

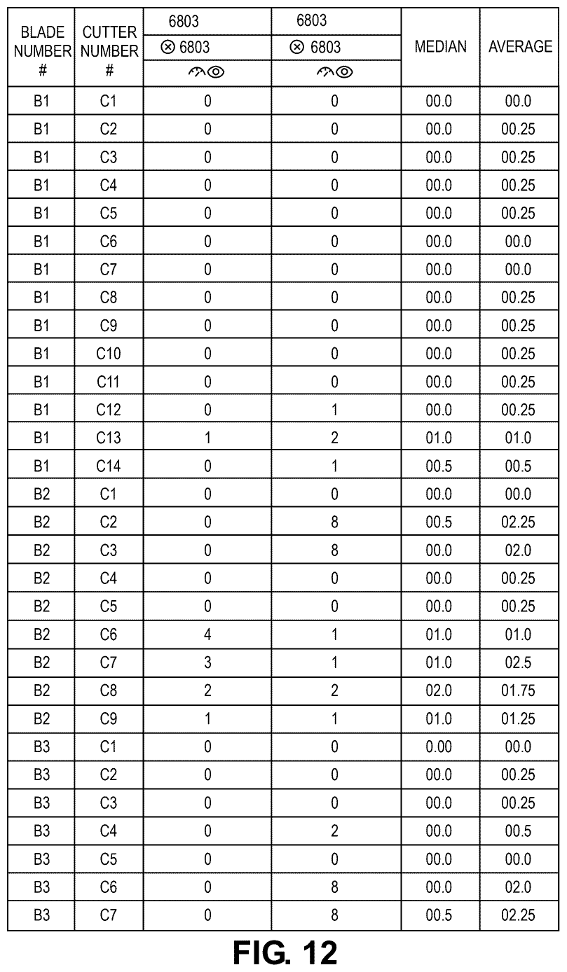

FIG. 12 illustrates a table comparing damage on two scans cutter-by-cutter, according to an embodiment. As part of dull grading, dull/wear conditions for each cutter may be captured. As part of this capture, additional environmental data such as drill bit run parameters are also linked. This provides an opportunity to compare dull/wear conditions across scans and factors in additional usage/environmental conditions.

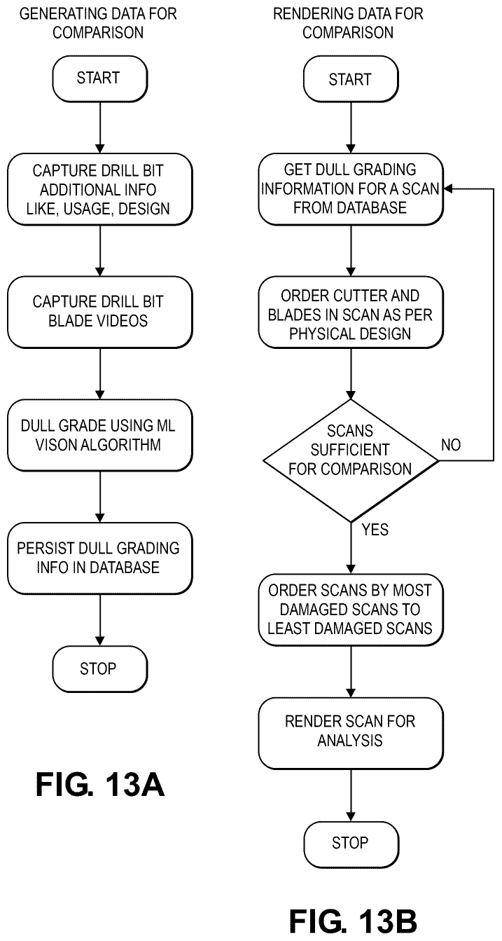

FIG. 13A illustrates a flowchart of a method for generating data for comparison, and FIG. 13B illustrates a flowchart of a method for rendering data for comparison, according to an embodiment. The dull and wear analysis may include (1) capturing the drill bit blade videos, (2) capturing additional data for the drill bit, (3) determining the dull and wear conditions using ML, (4) filtering the interested set of scans (e.g., captures) by additional data such as usage, location, and/or make, and (5) rendering the scans vertically in blade number, cutter position order, and horizontally by damage, with the minimum on the left and maximum on the right. T1 is the minimum and T8 is the maximum damage.

This may help to identify which drill bits are performing well (e.g., have less damage) when filtered with the run location. This may also help to identify which cutters are performing well when filtered with make or drill bit design, identify a run location effect on drill bit cutter conditions when compared across run locations, and/or identify better cutters for new drill bit design.

### Tools to Identify Wear Grade

In the cutter analytics application, a dull grading model leverages a comprehensive image dataset and object detection techniques. Annotating cutters involves drawing bounding boxes around them and categorizing them into one of ~37 predefined categories, such as SP_T5_P_X. In this notation, SP denotes the dull code, T5 signifies the wear code, and P indicates whether the cutter is positioned on the primary or secondary section of the blade. Human annotators often struggle with accurately labeling these categories due to inherent subjectivity and lack of extensive knowledge. This variability in human annotations introduces inconsistencies into the model's learning process, thereby diminishing its accuracy. Consequently, establishing a standardized annotation procedure is helpful to address these challenges and ensure reliable and consistent labeling.

To do that, the method may include two ways to guide annotators to correctly identify the wear grade of a cutter. Both tools rely on projecting 8 equal divisions on the cutter to guide the appropriate wear grade. The first tool tries to automatically project a circle or ellipse on top of cutters on a blade image. This tool is designed to be added to the cutter analytics training page. The second tool projects a square box on top of the cutters in the blade image.

Automatic Circle/Ellipse Generation from the Images

The blade images may contain multiple cutters and an object detection model. The process begins by taking a blade image as input into the object detection model, which identifies the cutters. Based on the bounding box coordinates provided by the model, the method crops the images to isolate individual cutters. Subsequently, image smoothing and edge detection techniques may be applied to these cropped cutter images.

Next, the method may apply the RANSAC (random sample consensus) algorithm. If a circle parameter is relevant, the algorithm generates a circle that encloses the cutter, followed by generating and displaying circle chords on the cutter. Conversely, if an ellipse parameter is relevant, the algorithm generates an ellipse that encloses the cutter, followed by generating and displaying ellipse chords on the cutter. There may be 7 chords to divide the cutter into 8 divisions mimicking the wear grading scale.

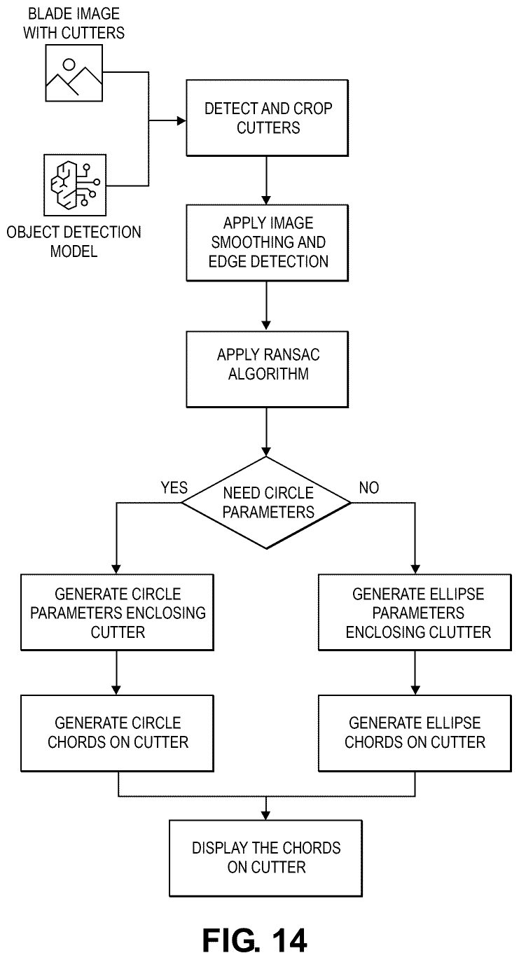

FIG. 14 illustrates a flowchart of a method for generating a circle or ellipse on the cutters, according to an embodiment. More particularly, the method automates the identification of circle and ellipse geometries, visualizes wear code damage, and provides an automated approach to determine the wear code for annotation.

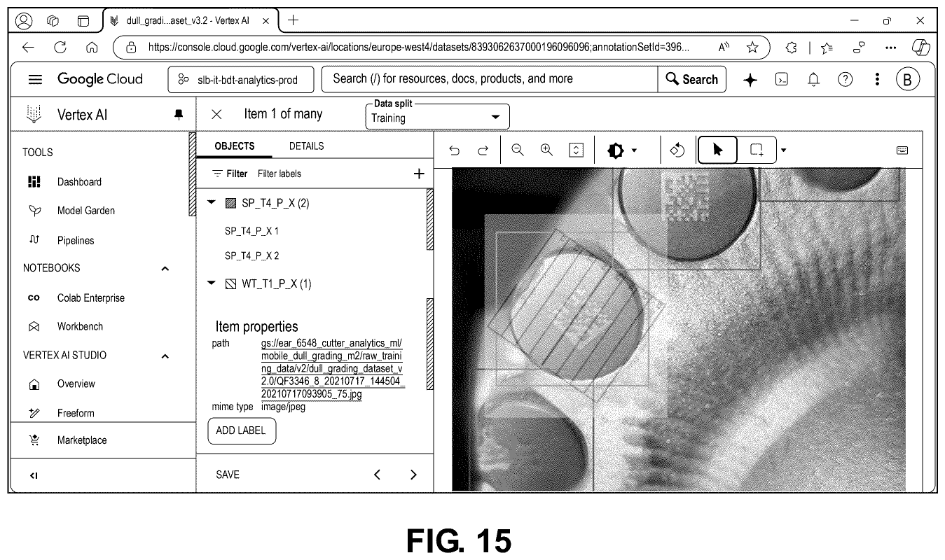

FIG. 15 illustrates an image of a Tkinter tool hovering over an image, according to an embodiment. The Tkinter tool creates an interactive interface where a square containing a circle is divided into 8 equal parts. This circle is transparent and can be manipulated to match the cutter's axis. The circle can be moved up-down, left-right, and/or rotated. Additionally, it can be transformed into an oval/ellipse shape to fit cutters that are not perfectly circular in the image.

The tool aids in accurately identifying the wear code of the cutter by first fitting the circle or oval/ellipse to the cutter and aligning it with the cutter's axis. It then provides the scales to estimate the damage present to determine the maximum wear code. Based on this, the user can accurately decide the wear code, which in turn makes it easier to identify the dull code. The tool addresses border cases, such as when damage is ⅜, which could fall into either the T3 or T4 zone of wear and is difficult to distinguish with the naked eye. This tool removes judgmental errors and enhances model performance by providing standardized annotations.

### Tool Functionality

The Tkinter tool for dull and wear code annotation provides an intuitive interface for annotating cutters. The tool includes functionalities that allow users to move, resize, and rotate cutters using mouse and keyboard inputs. The combination of automatic circle/ellipse generation and the Tkinter tool for wear code identification provides a robust and standardized approach to cutter annotation. These tools mitigate subjectivity, enhance accuracy, and streamline the annotation process, ultimately improving the model's performance and ensuring consistent, reliable data for dull grading in drilling operations.

Enhanced Video Capturing with Device Sensors and ML Models

Cutter analytics is based on the evaluation of images and videos which provide dull grading results. Capturing videos is a component for the whole process as these videos are sent for processing. The videos obtained should not be captured in either slow or fast movement. They should not be blurry as this may create a problem in cutter identification, and they should be in the direction of the first cutter to the last cutter in the blade. They should also not take too much time as this may hamper the video processing.

### ML Model for Detecting Number of Blades on a Drill Bit

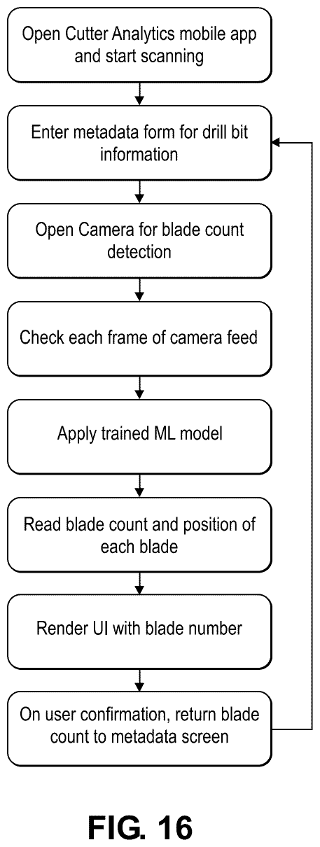

FIG. 16 illustrates a flowchart of a method for detecting the number of blades on a drill bit, according to an embodiment. The ML model may detect the number of blades on a drill bit. This may be used to automatically fill this information in the user form before the user starts scanning. This model processes each frame from the camera stream/feed, evaluates position of the blade, and plots it on a live camera screen. The ML model takes a video frame as an input and provides an array of blade locations along with mid-point of the drill bit. Using this information, the method may determine the number of blades on the bit. This information may be used later to capture the same number of blade videos.

The object detection model may be trained to detect blades present on the drill bit images. These images are taken from the top view of the drill bit and capture the blades present in the bit. These images may be annotated with bounding boxes of blades to identify one class (i.e., blade) and used for model training in the GCP platform using the auto-ML libraries provided by them. The trained model may then be exported as TFLite file to use in our iOS application.

### ML Model for Cutter Detection

While capturing the blade video, the rectangle boxes on the cutters may be displayed on the camera feed to guide the users. This may help the users to better capture the videos and thus better dull grading results. The object detection model may be used to detect the cutters on the feed and display them on the camera feed in real time. The confidence of the model predictions may be displayed along with the bounding boxes (e.g., rectangle boxes) of the cutters.

The object detection model may be trained to detect the cutters on a video frame (e.g., image). The frames may be collected from the blade videos uploaded by users. The cutters may be annotated with bounding boxes. These images may then be used for the object detection model to identify one class (i.e., cutter) and provide the cutter bounding box coordinates. The model may be trained on the GCP platform with the auto-ML libraries. The model may be exported as a TF lite file to use it in the iOS application to have real time prediction.

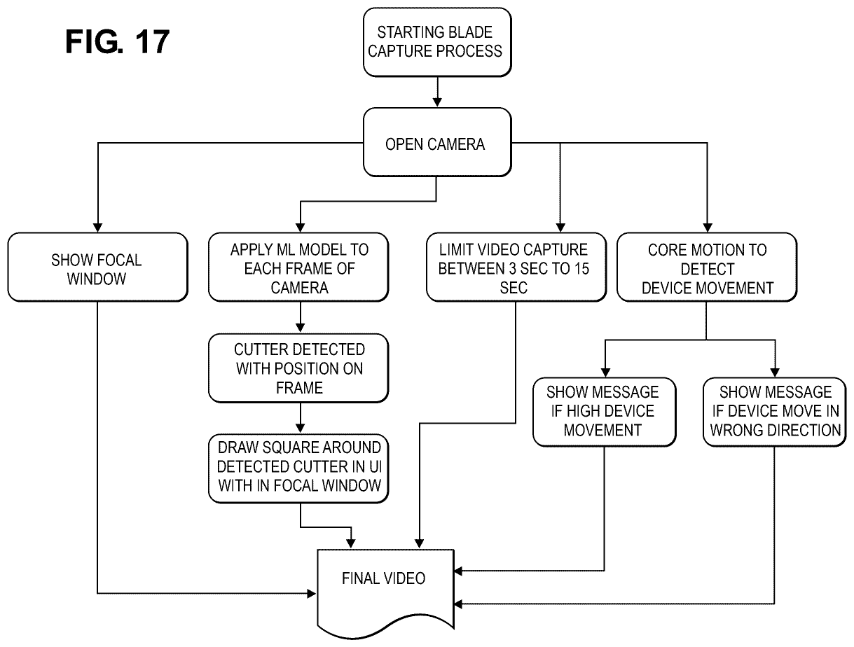

FIG. 17 illustrates a flowchart of a method for capturing a video of a blade, according to an embodiment. When the camera is triggered to record a video of blade of a drill bit, a focal window may be applied on top of the camera screen, displaying rectangular boxes around the cutters. The video duration may be between 4-30 seconds, and core motion sensor detection activity may initiate. These parameters may be used for guiding the user to capture right video for dull grade process.

The focal window is designed in such a way that users can see through it, and it focus on a single cutter while recording a video. The size of focal window may be set to 400*400 pixels, and other parts of the screen may be greyed out with an opacity of 0.5. The zoom level of the camera is set to 2x, so the cutter fits easily within the focal window. With this focal window, the user can have more confidence on each cutter to get the right capture with each frame.

Core motion is a framework provided by Apple for iOS devices that allows developers to access data from the device's accelerometer, gyroscope, magnetometer, and pedometer. This framework enables the users to detect and respond to device movement and orientation changes. In an example, core motion sensors may be used to identify how the mobile device is moving while recording a video. To understand the device motion, the attitude and its directions may be monitored with x, y and z axis coordinates.

The following is the pseudo code (written in swift) for detection of movement:

```
motionManager.startAccelerometerUpdates(to: OperationQueue.current!)
{ (data, error) in
    if let motionData = data {
      let x_axis = accelerationData.acceleration.x
      let y_axis = accelerationData.acceleration.y
      let z_axis = accelerationData.acceleration.z
    completionHandler(Double(round(100000 * x_axis)/100000),
    Double(round(100000 * y_axis)/100000), Double(round(100000 *
    z_axis)/100000))
    }
  }
```

As its name suggests, the accelerometer sensor can be used to measure the acceleration exerted upon the sensor. The acceleration may be given in two or three axis vector components that make up the sum acceleration.

The core motion sensors may be used to identify the direction of device movement while recording a video. To understand the device motion, the sensors collect information such as attitude and its pitch, roll, and yaw. The following is pseudo code (written in Swift) for detection of movement:

```
motionManager.startDeviceMotionUpdates(to: OperationQueue.current!)
{ (data, error) in
  if let motionData = data {
    let x_axis = motionData.attitude.pitch
    let y_axis = motionData.attitude.roll
    let z_axis = motionData.attitude.yaw
  completionHandler(Double(round(100000 * x_axis)/100000),
  Double(round(100000 * y_axis)/100000), Double(round(100000 *
  z_axis)/100000))
  } }
```

Once the device-motion updates are received, the method may determine the desired angles of rotation from the CMDeviceMotion object returned by the update handler. This class has a property called attitude, which describes the rotation of our device in terms of roll, pitch, and yaw. Pitch refers to the rotation of an object around its side-to-side axis. For a mobile device, pitching it forward would mean tilting the top of the device away from the user, while pitching it backward would tilt the top towards the user. Roll refers to the rotation of an object around its front-to-back axis. For a mobile device, rolling it to the left would mean rotating the left side of the device upward while the right side moves downward, and vice versa for rolling to the right. Yaw refers to the rotation of an object around its vertical axis. For a mobile device, yawing it to the left would rotate the top of the device to the left while the bottom moves to the right, and vice versa for yawing to the right.

### Expedited Cutter Detection for User Confirmation

In the dynamic world of oil and Gas drilling, it is beneficial for users to have real-time access to their IADC results and be able to validate their cutter data promptly. To achieve this, tracking and ordering of cutters may be performed (e.g., on a mobile device).

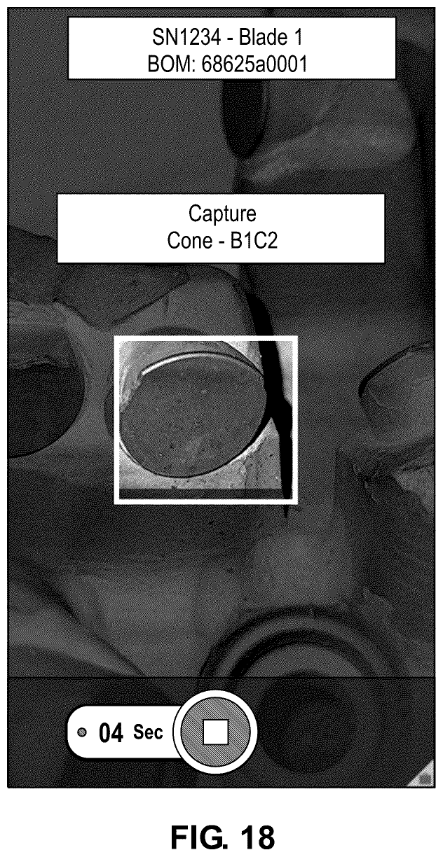

FIG. 18 illustrates a frame from a video showing a focal window that aids users in capturing clear images of cutters, according to an embodiment. This may enhance cutter tracking and prevent the capture of cutters from adjacent drill bit blades. After tracking and ordering the cutters, an immediate confirmation screen may be presented to verify that the cutters have been accurately captured and ordered. This confirmation screen may displays the primary and/or secondary lists of cutters. The drill bit configuration data (e.g., cfg) may then be fetched from the engineering design libraries and displayed on the UI to confirm that the application has the correct cutter count and placement.

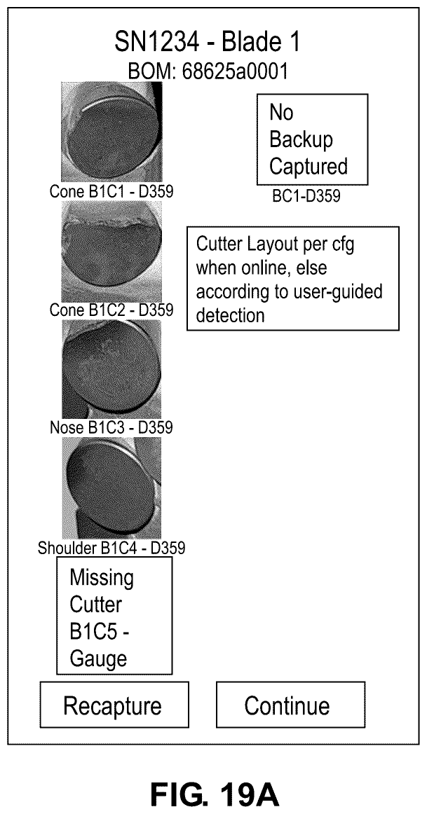

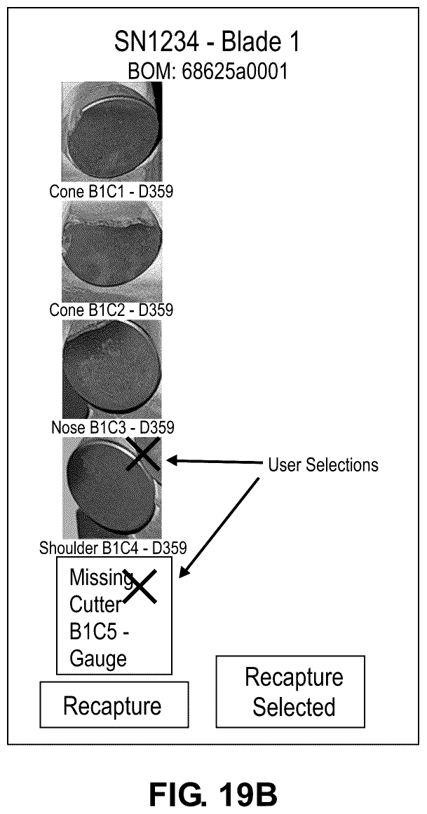

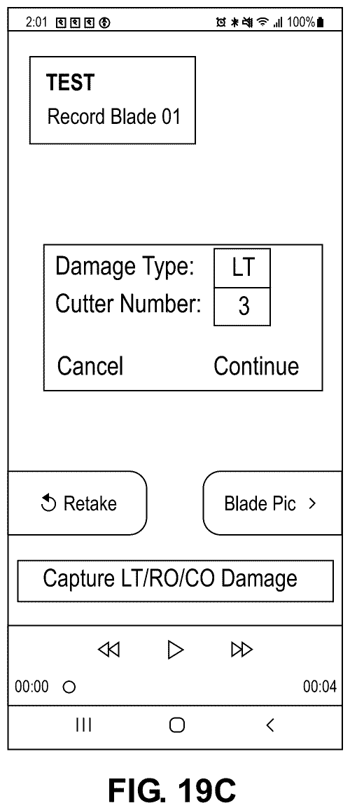

FIGS. 19A-19C illustrate images showing how to address a missing cutter, according to an embodiment. If/when the cfg is unavailable, the confirmation screen may display the cutters detected and allow for user edits. When a cutter is missing (e.g., due to excessive bit or user error), the user may have an option to adjust the captured cutters order and photograph the missing cutter or pocket/blade damage. These conditions may be referred to as Ring-Out (RO), Core-Out (CO) and LT (Lost Tooth or Cutter).

### Exemplary Method

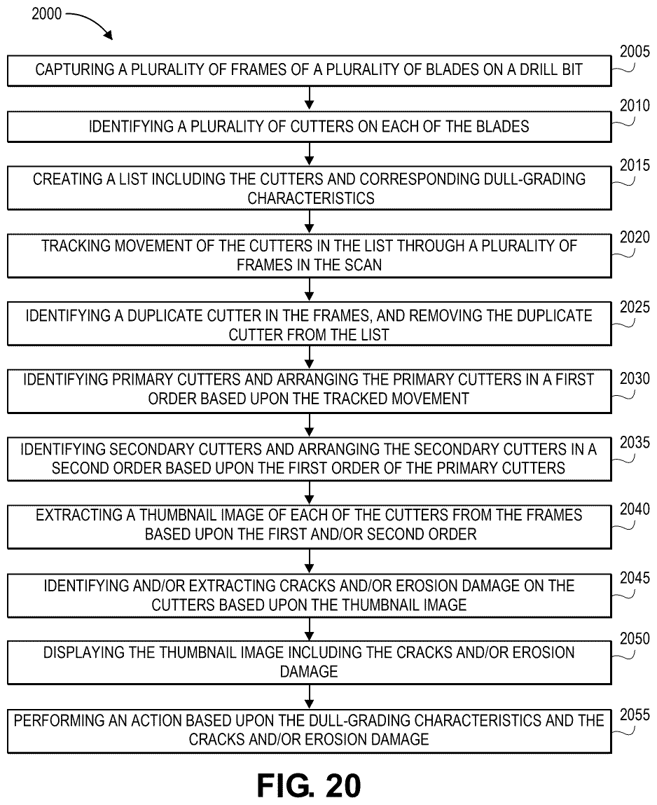

FIG. 20 illustrates a flowchart of a method for identifying, ordering, and dull-grading a plurality of cutters on a drill bit, according to an embodiment. An illustrative order of the method 2000 is provided below; however, one or more portions of the method 2000 may be performed in a different order, simultaneously, repeated, or omitted. At least a portion of the method 2000 may be performed with a computing system (described below).

The method 2000 may include capturing a plurality of frames of a plurality of blades on a drill bit, as at 2005. The frames may be images and/or video frames. The frames may be captured using an edge device.

The method 2000 may also include identifying a plurality of cutters on each of the blades in the frames, as at 2010. Identifying the cutters may include selecting one or more frames from the plurality of frames. In an example, the one or more selected frames may include every 3^{rd} of the frames and/or every 5th of the frames. Identifying the cutters may also include identifying the cutters within the one or more selected frames. Identifying the cutters may also include determining dull-grading characteristics for the cutters within the one or more selected frames. The dull-grading characteristics may include a dull code, a wear code, a designation of type of the cutters, or a combination thereof.

The method 2000 may also include creating a list including the cutters within the one or more selected frames and the corresponding dull-grading characteristics, as at 2015.

The method 2000 may also include tracking movement of the cutters in the frames, as at 2020. The movement of the cutters in the list is tracked through the frames.

The method 2000 may also include identifying a duplicate cutter in the frames based upon the tracked movement, and removing the duplicate cutter from the list, as at 2025. In an example, one of the cutters may be identified as the duplicate cutter in response to the cutter (1) being within 100 pixels or less of the same location in two or more of the frames and/or (2) having the same dull grading characteristics.

The method 2000 may also include identifying a first subset of the cutters that are primary cutters and arranging the primary cutters in a first order based upon the tracked movement, as at 2030. Arranging the primary cutters may include identifying a first of the primary cutters in the list based upon locations of the cutters in the frames. A frame of reference extends through a centroid of the first primary cutter. The frame of reference may be generated by first and second lines. The first and second lines may be mis-aligned. The first line may be oriented at a first angle with respect to a horizontal line, and the second line may be oriented at a second (e.g., different) angle with respect to the horizontal line. In an example, the first angle is 105 degrees, and the second angle is 295 degrees. The locations of centroids of remaining primary cutters are on a left side of the frame of reference with respect to the first primary cutter.

Arranging the primary cutters may also include identifying a second of the primary cutters. The second primary cutter may be a nearest of the remaining primary cutters to the first primary cutter and is also between 135 degrees and 285 degrees from the centroid of the first primary cutter.

The method 2000 may also include identifying a second subset of the cutters that are secondary cutters and arranging the secondary cutters in a second order based upon the first order of the primary cutters, as at 2035. Arranging the secondary cutters may include identifying a first of the secondary cutters in the list that is (1) nearest to the one of the primary cutters, (2) within a distance of about 80 pixels to about 310 (or 400) pixels from the nearest primary cutter, and/or (3) within an angle from about 80 degrees to about 190 degrees to the nearest primary cutter. Arranging the secondary cutters may also include identifying a second of the secondary cutters that is (1) nearest to the first secondary cutter and/or (2) within between 135 degrees and 285 degrees from a centroid of the first secondary cutter.

The method 2000 may also include extracting one or more thumbnail images of each of the cutters from the frames, as at 2040. For example, this may include extracting one (e.g., the best) thumbnail image of each primary cutter and/or each secondary cutter. The one or more thumbnail images of the primary cutters may be extracted in the first order, and the one or more thumbnail images of the secondary cutters may be extracted in the second order. The one or more extracted thumbnail images may be selected for extraction based on a weighted score that includes a blur score, a BRISQUE score, and/or a brightness score from the one or more extracted thumbnails of each of the cutters.

The method 2000 may also include identifying and/or extracting cracks and/or erosion damage on the cutters based upon the one or more extracted thumbnail images, as at 2045.

The method 2000 may also include displaying the one or more thumbnail images including the cracks and erosion damage, as at 2050.

The method 2000 may also include performing an action based on the dull-grading characteristics and/or the cracks and/or erosion damage, as at 2055. Performing the action may be or include generating and/or transmitting a signal that recommends, instructs, and/or causes a physical action to occur. The physical action may be or include rotating the cutters, replacing the cutters, repairing the drill bit, or a combination thereof.

### Exemplary Computing System

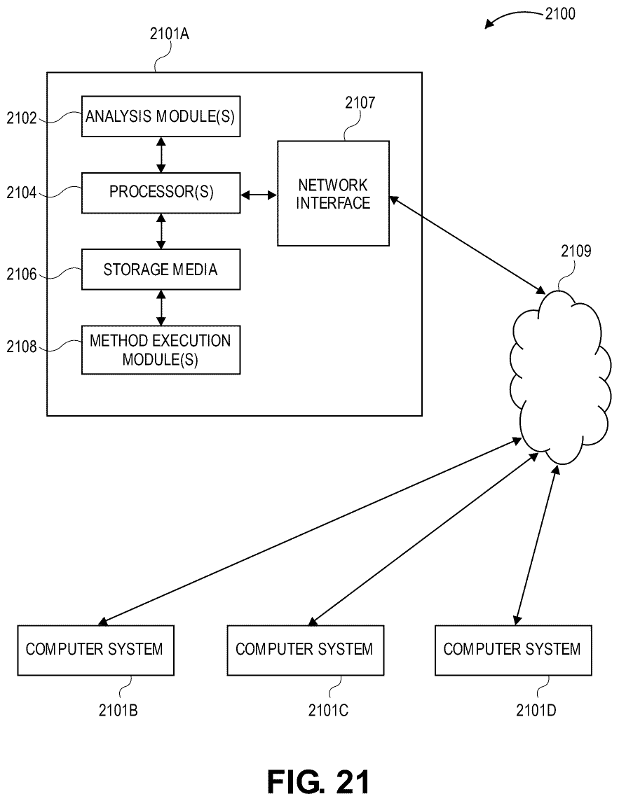

In some embodiments, the methods of the present disclosure may be executed by a computing system. FIG. 21 illustrates an example of such a computing system 2100, in accordance with some embodiments. The computing system 2100 may include a computer or computer system 2101A, which may be an individual computer system 2101A or an arrangement of distributed computer systems. The computer system 2101A includes one or more analysis modules 2102 that are configured to perform various tasks according to some embodiments, such as one or more methods disclosed herein. To perform these various tasks, the analysis module 2102 executes independently, or in coordination with, one or more processors 2104, which is (or are) connected to one or more storage media 2106. The processor(s) 2104 is (or are) also connected to a network interface 2107 to allow the computer system 2101A to communicate over a data network 2109 with one or more additional computer systems and/or computing systems, such as 2101B, 2101C, and/or 2101D (note that computer systems 2101B, 2101C and/or 2101D may or may not share the same architecture as computer system 2101A, and may be located in different physical locations, e.g., computer systems 2101A and 2101B may be located in a processing facility, while in communication with one or more computer systems such as 2101C and/or 2101D that are located in one or more data centers, and/or located in varying countries on different continents).

A processor may include a microprocessor, microcontroller, processor module or subsystem, programmable integrated circuit, programmable gate array, or another control or computing device.

The storage media 2106 may be implemented as one or more computer-readable or machine-readable storage media. Note that while in the example embodiment of FIG. 21 storage media 2106 is depicted as within computer system 2101A, in some embodiments, storage media 2106 may be distributed within and/or across multiple internal and/or external enclosures of computing system 2101A and/or additional computing systems. Storage media 2106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 2100 contains one or more de-risking module(s) 2108. In the example of computing system 2100, computer system 2101A includes the de-risking module 2108. In some embodiments, a single de-risking module may be used to perform some aspects of one or more embodiments of the methods disclosed herein. In other embodiments, a plurality of de-risking modules may be used to perform some aspects of methods herein.

It should be appreciated that computing system 2100 is merely one example of a computing system, and that computing system 2100 may have more or fewer components than shown, may combine additional components not depicted in the example embodiment of FIG. 21, and/or computing system 2100 may have a different configuration or arrangement of the components depicted in FIG. 21. The various components shown in FIG. 21 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 2100, FIG. 21), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for identifying, ordering, and dull-grading a plurality of cutters on a drill bit, the method comprising:
capturing a plurality of frames of a plurality of blades on a drill bit;
identifying a plurality of cutters on each of the blades in the frames;
identifying a first subset of the cutters that are primary cutters and arranging the primary cutters in a first order;
identifying a second subset of the cutters that are secondary cutters and arranging the secondary cutters in a second order;
extracting one or more thumbnail images of each of the cutters from the frames in the first order and/or the second order; and
identifying cracks and/or erosion damage on the cutters based upon the one or more extracted thumbnail images.

2. The method of claim 1, wherein arranging the primary cutters comprises identifying a first of the primary cutters based upon locations of the cutters in the frames, wherein a frame of reference extends through a centroid of the first primary cutter, and wherein the frame of reference comprises first and second lines.

3. The method of claim 2, wherein the first and second lines are mis-aligned.

4. The method of claim 2, wherein the first line is oriented at a first angle with respect to a horizontal line, wherein the second line is oriented at a second angle with respect to the horizontal line, and wherein the second angle is different than the first angle.

5. The method of claim 4, wherein the first angle from about 95 degrees to about 115 degrees, and wherein the second angle is from about 285 degrees to about 305 degrees.

6. The method of claim 2, wherein locations of centroids of a remaining portion of the primary cutters are on a left side of the frame of reference that extends through the first primary cutter.

7. The method of claim 6, wherein arranging the primary cutters further comprises identifying a second of the primary cutters, and wherein the second primary cutter is a nearest of the remaining portion of the primary cutters that is on the left side of the frame of reference that extends through the first primary cutter.

8. The method of claim 7, wherein the second primary cutter is also between 135 degrees and 285 degrees from the centroid of the first primary cutter.

9. The method of claim 1, further comprising displaying the one or more thumbnail images including the cracks and erosion damage.

10. The method of claim 1, further comprising performing an action based on dull-grading characteristics of the cutters and the cracks and/or erosion damage, wherein performing the action comprises rotating the cutters, replacing the cutters, repairing the drill bit, or a combination thereof.

11. A computing system, comprising:
one or more processors; and
a memory system comprising one or more non-transitory computer-readable media storing instructions that, when executed by at least one of the one or more processors, cause the computing system to perform operations, the operations comprising:
capturing a plurality of frames of a plurality of blades on a drill bit;
identifying a plurality of cutters on each of the blades in the frames;
identifying a first subset of the cutters that are primary cutters and arranging the primary cutters in a first order;
identifying a second subset of the cutters that are secondary cutters and arranging the secondary cutters in a second order based upon the first order of the primary cutters;
extracting one or more thumbnail images of each of the cutters from the frames in the first order and/or the second order;
identifying cracks and/or erosion damage on the cutters based upon the one or more extracted thumbnail images; and
displaying the one or more extracted thumbnail images including the cracks and/or erosion damage.

12. The computing system of claim 11, wherein identifying the cutters comprises:
selecting one or more frames from the plurality of frames, wherein the one or more selected frames comprise every 3^{rd} of the frames and/or every 5th of the frames;
identifying the cutters within the one or more selected frames; and
determining dull-grading characteristics for the cutters within the one or more selected frames, wherein the dull-grading characteristics comprise a dull code, a wear code, a designation of type of the cutters, or a combination thereof.

13. The computing system of claim 11, wherein arranging the secondary cutters comprises identifying a first of the secondary cutters that is nearest to the one of the primary cutters and within a distance of about 80 pixels to about 400 pixels from the nearest primary cutter.

14. The computing system of claim 13, wherein the first secondary cutter is also within an angle from about 80 degrees to about 190 degrees from a centroid of the nearest primary cutter.

15. The computing system of claim 14, wherein arranging the secondary cutters further comprises identifying a second of the secondary cutters that is nearest to the first secondary cutter and within an angle between 135 degrees and 285 degrees from a centroid of the first secondary cutter.

16. A non-transitory computer-readable medium storing instructions that, when executed by one or more processors of a computing system, cause the computing system to perform operations, the operations comprising:
capturing a plurality of frames of a plurality of blades on a drill bit;
identifying a plurality of cutters on each of the blades in the frames;
identifying a first subset of the cutters that are primary cutters and arranging the primary cutters in a first order;
identifying a second subset of the cutters that are secondary cutters and arranging the secondary cutters in a second order based upon the first order of the primary cutters;
extracting one or more thumbnail images of each of the cutters from the frames, wherein the one or more thumbnail images of the primary cutters are extracted in the first order, wherein the one or more thumbnail images of the secondary cutters are extracted in the second order, and wherein the one or more thumbnail images are extracted based on a weighted score that includes a blur score, a BRISQUE score, and/or a brightness score;
identifying cracks and/or erosion damage on the cutters based upon the one or more extracted thumbnail images; and
displaying the one or more extracted thumbnail images including the cracks and/or erosion damage.

17. The non-transitory computer-readable medium of claim 16, wherein identifying the cutters comprises:
selecting one or more frames from the plurality of frames, wherein the one or more selected frames comprise every 3^{rd} of the frames and/or every 5th of the frames;
identifying the cutters within the one or more selected frames; and
determining dull-grading characteristics for the cutters within the one or more selected frames, wherein the dull-grading characteristics comprise a dull code, a wear code, a designation of type of the cutters, or a combination thereof.

18. The non-transitory computer-readable medium of claim 17, wherein the operations further comprise:
creating a list comprising the cutters within the one or more selected frames and the corresponding dull-grading characteristics;
tracking movement of the cutters in the list through the frames; and
identifying a duplicate cutter in the frames based upon the tracked movement, and removing the duplicate cutter from the list, wherein one of the cutters is identified as the duplicate cutter in response to the cutter (1) being within 100 pixels or less of a same location in two or more of the frames and (2) having the same dull grading characteristics.

19. The non-transitory computer-readable medium of claim 18, wherein arranging the primary cutters comprises:
identifying a first of the primary cutters in the list based upon locations of the cutters in the frames, wherein a frame of reference extends through a centroid of the first primary cutter, wherein the frame of reference is generated by first and second lines, wherein the first and second lines are mis-aligned, wherein the first line is oriented at a first angle with respect to a horizontal line, wherein the second line is oriented at a second angle with respect to the horizontal line, wherein the first angle is 105 degrees, wherein the second angle is 295 degrees, and wherein the locations of centroids of a remaining portion of the primary cutters are on a left side of the frame of reference with respect to the first primary cutter; and
identifying a second of the primary cutters, wherein the second primary cutter is a nearest of the remaining portion of the primary cutters to the first primary cutter and is also between 135 degrees and 285 degrees from the centroid of the first primary cutter.

20. The non-transitory computer-readable medium of claim 19, wherein arranging the secondary cutters comprises:
identifying a first of the secondary cutters in the list that is (1) nearest to the one of the primary cutters, (2) within a distance of about 80 pixels to about 400 pixels from the nearest primary cutter, and (3) within an angle from about 80 degrees to about 190 degrees to the nearest primary cutter; and
identifying a second of the secondary cutters that is (1) nearest to the first secondary cutter and (2) between 135 degrees and 285 degrees from a centroid of the first secondary cutter.
